(19) United States
(12) Patent Application Publication
(10) Pub. No.: US 2022/0100191 A1
(43) Pub. Date: Mar. 31, 2022

(54) INTELLIGENT DEVICE AND SWITCHING METHOD THEREOF

(71) Applicant: Powervision (Suzhou) Technology Co., Ltd., Changshu City (CN)

(72) Inventors: Weifeng Zheng, Changshu City (CN); Junjie Jia, Changshu City (CN); Shaohua CUI, Changshu City (CN); Yanqing YANG, Changshu City (CN); Xingqiang PAN, Changshu City (CN); Weilong LU, Changshu City (CN); Baoyi ZHANG, Changshu City (CN); Tong BAI, Changshu City (CN)

(73) Assignee: Powervision (Suzhou) Technology Co., Ltd., Changshu City (CN)

(21) Appl. No.: 17/527,141

(22) Filed: Nov. 15, 2021

Related U.S. Application Data
(63) Continuation-in-part of application No. 17/491,545, filed on Oct. 1, 2021, now abandoned.
Application No. 17/491,545 is a continuation-in-part of application No. PCT/CN2019/130771, filed on Dec. 31, 2019.

(30) Foreign Application Priority Data
Apr. 1, 2019 (CN) 201910257812.7
May 10, 2019 (CN) 201910390340.2
Sep. 9, 2019 (CN) 201910849426.7
Sep. 9, 2019 (CN) 201910850139.8

(51) Int. Cl. G05D 1/00; G06F 1/16

(52) U.S. Cl. CPC G05D 1/0088; G05D 1/0016; G06F 1/163; G05D 1/0022

(57) ABSTRACT

The present disclosure proposes an intelligent device that comprises a body comprising a controller and a first interface; the controller is in connection with the first interface; the body of the intelligent device is connected with an external device via the first interface; different external devices are connected with the body of the intelligent device to form various intelligent devices so as to meet the use requirements in different scenes.

### CROSS REFERENCE TO RELATED APPLICATIONS

This application is a continuation-in-part of U.S. application Ser. No. 17/491,545, filed on Oct. 1, 2021, which is a continuation-in-part of PCT Application No. PCT/CN2019/130771, which was filed on Dec. 31, 2019, and is incorporated herein by reference.

### BACKGROUND OF THE INVENTION

### 1. Field of the Invention

The present disclosure relates to an intelligent device and switching method thereof, falling into the technical field of intelligent devices.

### 2. Description of the Prior Art

At present, an unmanned aerial vehicle (UAV), an unmanned ship and other intelligent devices all belong to single-domain technologies, but may not be applied across domains. If one desires a UAV to navigate on the water, extra refitting or addition of some necessary external device is needed, and the refitted product further needs to be debugged before it may be used normally. Amphibious conversion also involves such challenging problems as watertightness and dust resistance, which may not be completed by non-professionals, thereby seriously limiting the multi-domain application and popularization of intelligent devices.

### SUMMARY OF THE INVENTION

In accordance with one aspect of the present disclosure, provided is an intelligent device comprising a body comprising: a first interface connected with an external device; and a controller connected with the first interface; wherein device modes of the intelligent device include a handheld mode and a self-propelled device mode according to the first interface and the external device; and when the intelligent device is in the self-propelled device mode, the controller is configured to control the external device.

In accordance with another aspect of the present disclosure, provided is an intelligent device comprising: a body comprising a first structural connection port and a master connection contact, the first master connection contact being arranged on the first structural connection port; and an external device comprising a slave connection contact; wherein the body is connected with and/or quickly released from the external device via the first structural connection port; and when the body is in connection with the external device, the master connection contact is electrically connected with the slave connection contact.

In accordance with one further aspect of the present disclosure, provided is an intelligent device comprising a body, a UAV arm and a bracket, the body comprising a first interface for alternatively connecting the UAV arm or the bracket.

In accordance with one more aspect of the present disclosure, provided is a switching method applied to an intelligent device, the switching method comprising: determining whether the intelligent device satisfies a state switching condition; and switching the intelligent device from a first state to a second state when the state switching condition is satisfied.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a body of an intelligent device according to the present disclosure;

FIG. 2 is a diagram illustrating a first type of connection among the internal components of the body of the intelligent device according to the present disclosure;

FIG. 3 is a diagram illustrating a second type of connection among the internal components of the body of the intelligent device according to the present disclosure;

FIG. 4 is a diagram illustrating the first interface of a first type according to one embodiment of the present disclosure;

FIG. 5 is a diagram illustrating the first interface of a second type according to one embodiment of the present disclosure;

FIG. 6 is a diagram illustrating the first interface of a third type according to one embodiment of the present disclosure;

FIG. 7 is a diagram illustrating the first interface of a fourth type according to one embodiment of the present disclosure;

FIG. 8 is a diagram illustrating the first interface of a fifth type according to one embodiment of the present disclosure;

FIG. 9 is a diagram illustrating a communication interface according to one embodiment of the present disclosure;

FIG. 10 is a diagram illustrating the external device of a first type according to one embodiment of the present disclosure;

FIG. 11 is a diagram illustrating the external device of a second type according to one embodiment of the present disclosure;

FIG. 12 is a diagram illustrating the external device of a third type according to one embodiment of the present disclosure;

FIG. 13 is a diagram illustrating the external device of a fourth type according to one embodiment of the present disclosure;

FIG. 14 is a diagram illustrating the external device of a fifth type according to one embodiment of the present disclosure;

FIG. 15 is a diagram illustrating a first switching between the external devices of the intelligent device according to one embodiment of the present disclosure;

FIG. 16 is a diagram illustrating a second switching between the external devices of the intelligent device according to one embodiment of the present disclosure;

FIG. 17 is a diagram illustrating a third switching between the external devices of the intelligent device according to one embodiment of the present disclosure;

FIG. 18 is a diagram illustrating the intelligent device of a first type according to one embodiment of the present disclosure;

FIG. 19 is a diagram illustrating the intelligent device of a second type according to one embodiment of the present disclosure;

FIG. 20 is an assembly diagram of an intelligent device according to one embodiment of the present disclosure in the mode of a UAV product;

FIG. 21 is an exploded view of the components of the intelligent device according to one embodiment of the present disclosure in the mode of a UAV product;

FIG. 22 is an assembly diagram of an intelligent device according to one embodiment of the present disclosure in the mode of a handheld DV product;

FIG. 23 is an exploded view of the components of the intelligent device according to one embodiment of the present disclosure in the mode of a handheld DV product;

FIG. 24 shows a perspective view of an UAV arm according to one embodiment of the present disclosure;

FIG. 25 shows a plan view of the UAV arm according to one embodiment of the present disclosure;

FIG. 26 shows a schematic diagram of the connection between the UAV arm and the UAV fuselage according to one embodiment of the present disclosure;

FIGS. 27 and 28 are exploded views of the UAV arm according to one embodiment of the present disclosure;

FIG. 29 shows a perspective view of the bottom side of the UAV arm according to one embodiment of the present disclosure;

FIG. 30 shows a partial enlargement view of the UAV arm according to one embodiment of the present disclosure, in which the upper cover is removed in order to clearly display a reinforcing structure therein;

FIG. 31 is an exploded view of the UAV arm according to one embodiment of the present disclosure, in which a leg of the arm is shown;

FIG. 32 shows a perspective view of the UAV arm;

FIG. 33 shows an exploded view of the UAV arm;

FIG. 34 shows an exploded view of the UAV arm at another angle;

FIG. 35 shows an enlarged view of the circle area A in FIG. 34;

FIG. 36 shows a perspective view of a retractable component;

FIG. 37 shows an exploded view of the UAV arm according to one embodiment of the present disclosure, in which a motor is shown;

FIG. 38 shows a perspective view of a propeller clamp according to one embodiment of the present disclosure;

FIG. 39 is a schematic diagram of the connection between the propeller clamp and the propellers according to one embodiment of the present disclosure;

FIG. 40 is a structural schematic diagram of the internal components of the body of the intelligent device according to one embodiment of the present disclosure;

FIG. 41 is a flowchart of a switching method according to one embodiment of the present disclosure;

FIG. 42 is a schematic diagram of the communication mode between an intelligent device and a ground control terminal according to one embodiment of the present disclosure;

FIG. 43 is a schematic diagram of another communication mode between an intelligent device and a ground control terminal according to one embodiment of the present disclosure;

FIG. 44 is a structural block diagram of a switching device according to one embodiment of the present disclosure;

FIG. 45 is a structural diagram of a handheld body provided by one example of the present disclosure from a first viewing angle;

FIG. 46 is a structural diagram of the handheld body provided by the example of the present disclosure from a second viewing angle;

FIG. 47 is a state diagram of an intelligent device in a handheld mode provided by one example of the present disclosure;

FIG. 48 is a state diagram of a flight mode battery being mounted in the handheld body provided by one example of the present disclosure;

FIG. 49 is a structural diagram of the intelligent device in a flight device mode provided by one example of the present disclosure from a first viewing angle; and

FIG. 50 is a structural diagram of the intelligent device in the flight device mode provided by the example of the present disclosure from a second viewing angle.

### DETAILED DESCRIPTION

Some embodiments of the present disclosure will be described below in detail referring to the accompanying drawings. Without conflict, the following examples and features therein may be combined or replaced with each other.

### First Aspect

FIG. 1 is a diagram illustrating a body of an intelligent device according to the present disclosure. The body of the intelligent device comprises a controller 103 (not shown in FIG. 1) and a first interface 101. The controller 103 is in connection with the first interface 101. And the body 104 is connected with an external device via the first interface 101.

In one embodiment of the present disclosure, the controller 103 may process data and send a control instruction, control the operation of a component on the body 104 according to the control instruction as is sent, and send an instruction to the external device via the first interface 101 to control the operation of the external device.

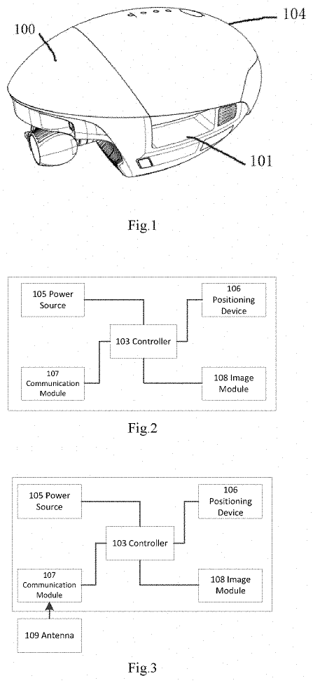

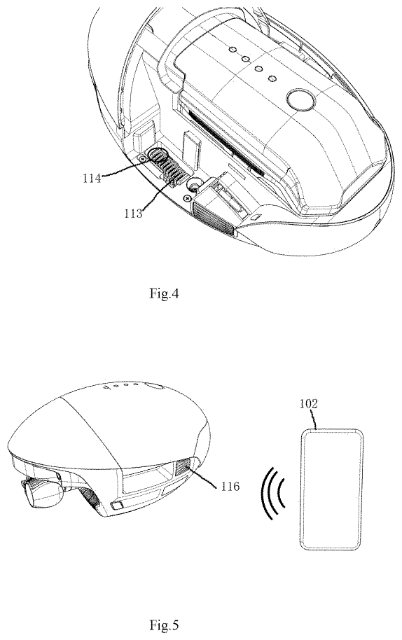

FIGS. 2-3 are diagrams illustrating connection among the internal components of the body 104 of the intelligent device of the present disclosure. The body of the intelligent device further comprises a power source 105, a positioning device 106, a communication module 107, an image module 108 and a housing 100. The controller 103 is connected with the power source 105, the positioning device 106, the communication module 107 and the image module 108 and is arranged in the housing 100 of the body 104 of the intelligent device of the intelligent device. The power source 105 supplies power to respective components of the body 104. Further, the power source 105 may also supply power to an external device via the first interface 101.

The positioning device 106 for determining position information about the intelligent device at least includes one or more of a vision sensor, a satellite positioning device, a TOF, a barometer and an ultrasonic sensor.

The communication module 107 for communication connection between the intelligent device and the outside is connected with the controller 103. The communication module 107 comprises an antenna 109. In one embodiment, the antenna 109 is arranged on the body 104 of the intelligent device. While in another embodiment, the antenna 109 is arranged on the external device 102, and the communication module 107 on the body 104 of the intelligent device is connected with the antenna 109 on the external device via the first interface 101.

The image module 108 for acquiring an image or video is connected with the controller 103 or with the communication module 107. The image module 108 is used to acquire the control instruction sent by the controller 103 or the control instruction received by the communication module 107, and the image module 108 is a camera 110. In one embodiment, the camera 110 is arranged on the body of the intelligent device via a gimbal, and the gimbal drives the camera 110 to rotate relative to the body to acquire images and videos from different directions or angles. While in another embodiment, the camera 110 is directly arranged on the body of the intelligent device to acquire images and videos from different directions or angles with the movement of the body of the intelligent device.

In one embodiment of the present disclosure, the first interface 101 is arranged on the body of the intelligent device, corresponding to a second interface of the external device, and connection between the body and the external device is established via the first interface and the second interface.

FIG. 4 is a diagram illustrating the first interface of a first type according to one embodiment of the present disclosure, in which the first interface is a wired interface 113, and the body of the intelligent device is connected with the external device 102 via the wired interface 113. The body performs data interaction with the external device via the wired interface 113, or the body performs power interaction with the external device via the wired interface 113. The power interaction means that the body supplies power to the external device via the wired interface 113, or the external device supplies power to the body via the wired interface 113. When the external device contains an electric device, the first interface then includes at least one data interface 114 for the electric device, and the body sends an instruction to the driving component and/or receives data returned by the driving component via the data interface 114 for the electric device. And the electric means may be a motor.

As described above, when the external device comprises an external battery component, the external battery component may also supply power to the body of the intelligent device via the wired interface 113. For example, the body of the intelligent device is an unmanned aerial vehicle (UAV), and the endurance of the UAV may be improved by connecting with the external device comprising the external battery component.

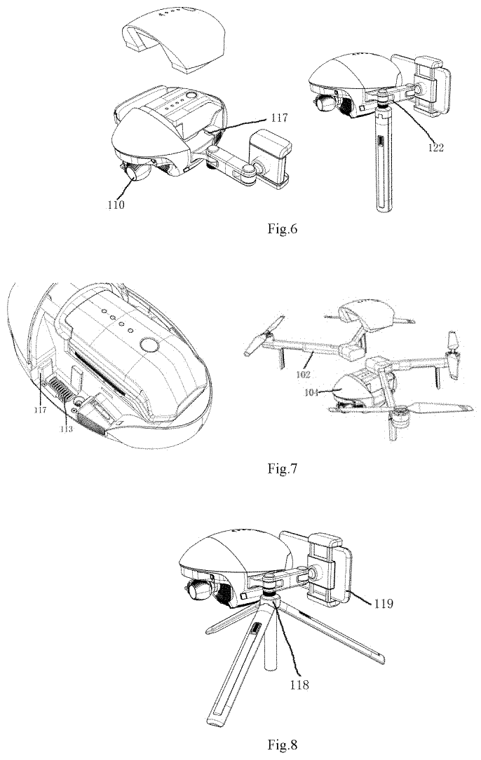

FIG. 5 is a diagram illustrating the first interface of a second type according to one embodiment of the present disclosure, in which the first interface is a wireless interface 116, and the body of the intelligent device is connected with the external device 102 via the wireless interface 116. The body performs data interaction with the external device 102 via the wireless interface 116. The wireless interface 116 includes at least one or more of WiFi and Bluetooth. When a distance value between the external device 102 and the body is less than a predefined threshold, automatic wireless connection or manual connection with the body via the external device 102 by the user is enabled, the manual connection here including such connections as are enabled by key press, image recognition, speech recognition, gesture recognition, somatic sensation and other means, and the predefined threshold here being a preset distance threshold between the external device 102 and the body. For example, the UAV flight is controlled by a mobile phone, and when the mobile phone and the UAV remain ON at the same time, and when a distance value between both is less than the predefined threshold, automatic connection is established, where the predefined threshold may be 100 m, 500 m and the like. Another example related to control the UAV flight by a mobile phone, and when the mobile phone and the UAV remain ON at the same time, the user selects connection with the UAV via the keys on the mobile phone.

Further, the first interface is a wired interface and/or a wireless interface.

FIG. 6 is a diagram illustrating the first interface of a third type according to one embodiment of the present disclosure, in which the first interface is a structural connection port 117, and the body of the intelligent device is connected with the external device via the structural connection port 117. Further, when the structural connection port 117 is a swallowtail-shaped connection port, the body of the intelligent device is in quick-release connection with the external device via the swallowtail-shaped connection port. For example, a bracket is added to the UAV with a camera, and a structural connection port 117 is arranged at a side of the UAV, the structural connection port 117 being a swallowtail-shaped connection port, then the bracket is in fixed connection with the UAV fuselage via the structural connection port 117, so that the UAV can be configured as a handheld camera.

FIG. 7 is a diagram illustrating the first interface of a fourth type according to one embodiment of the present disclosure, in which the first interface includes both a structural connection port 117 and a wired interface 113. The structural connection port 117 is used for fixed connection or quick-release connection between the external device 102 and the body 104 of the intelligent device, and the wired interface 113 is used for connection between an electronic connection component on the external device 102 and the body. Further, the wired interface 113 is arranged on the structural connection port 117, and when the external device 102 is connected with the body structure via the structural connection port 117, the body is in electronic connection with the external device 102 via the wired interface 113. When the external device 102 comprises an electric device, the body sends an instruction to a driving component and/or receives data returned by the driving component via the wired interface 113, in which the electric device may be a motor. For example, the body 104 of the intelligent device is a UAV fuselage, and the external device 102 is a UAV arm, and when the UAV arm is connected with the UAV fuselage via the structural connection port 117, the motor on the arm is connected with the fuselage controller via the wired interface 113, together forming the entirety of the UAV.

FIG. 8 is a diagram illustrating the first interface of a fifth type according to one embodiment of the present disclosure, in which the first interface includes a structural connection port 117 and a wireless interface 116. The structural connection port 117 is used for fixed connection or quick-release connection between the external device and the body of the intelligent device. The wireless interface 116 is used for wireless connection between the external device and the body. According to the combination of the first interfaces of the second type and the third type, the external device comprises a structural connection component 118 and an electronic connecting component 119, of which the structural connection component 118 is connected with the body via the structural connection port 117, and the electronic connection component 119 is connected with the body via the wireless interface 116. For example, a bracket is added at the bottom or side of the UAV, and a mobile phone is provided on the bracket through a mobile phone holder, thereby transforming the UAV into a handheld DV.

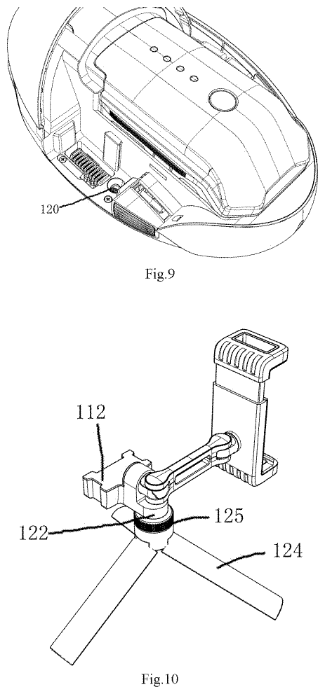

Further, as shown in FIG. 9, the first interface also comprises a communication interface 120, and the body of the intelligent device is connected with an external communication device via the communication interface 120. The external communication device is arranged on the external device, or the external communication device is exactly the external device. The first interface is a wired interface or a wireless interface. If the external communication device is an antenna, the communication module on the body is connected with the antenna via the communication interface, wherein the antenna is arranged on the external device, or the antenna is exactly the external device. If the external communication device is the communication module of the intelligent device, the body controller is connected with the external communication module via the communication interface.

The communication interface, if being a wired one, includes at least one or more of USB, UART, CAN, I2C, SPI, PWM and I/O. While the communication interface, if being a wireless one, includes at least one or more of WiFi and Bluetooth.

FIG. 10 is a diagram illustrating the external device of a first type according to one embodiment of the present disclosure, in which the external device is a structural connection component, and the external device is connected with the body of the intelligent device via the first interface.

In this embodiment, the external device is provided thereon with a second interface 112 that is connection component on the external device corresponding to the first interface 101 on the body, and the external device is connected, especially capable of being quick-release connected, with the body of the intelligent device via the second interface 112. For example, the external device is a bracket 122 or a wristband 140.

When the external device is a bracket 122, the bracket 122 comprises a support part 124 and the second interface 112. The support part 124 is in fixed connection or rotational connection with the second interface 112, the support part 124 is a cylindrical handheld structure or a triangular support structure bifurcated at a lower portion, and the top of the support part 124 is rotationally connected with the second interface 112 via a rotating shaft 125. The bracket 122 is connected with the UAV fuselage with a camera, so that the UAV may be transformed into a handheld camera or a fixed camera for use.

When the external device is a wristband, the wristband is provided with at least one second interface, via which the wristband is connected with the first interface on the body. The wristband is arranged on the UAV fuselage, so that the UAV may be transformed into a portable camera for use.

As shown in FIG. 5, the external device 102 is an electronic connection component. In this example, the electronic connection component may further be a human-computer interaction device, and the first interface on the body of the intelligent device is a wireless interface or a wired interface, so that the human-computer interaction device is connected with the body of the intelligent device via the first interface. The user controls interaction between the human-computer interaction device and the body of the intelligent device by touch control, image recognition, voice, key press and other means. For example, the human-computer interaction device is a mobile phone.

The electronic connection component may also be an external battery, and when the first interface is a wired or wireless interface, the external battery supplies power to the body via the first interface.

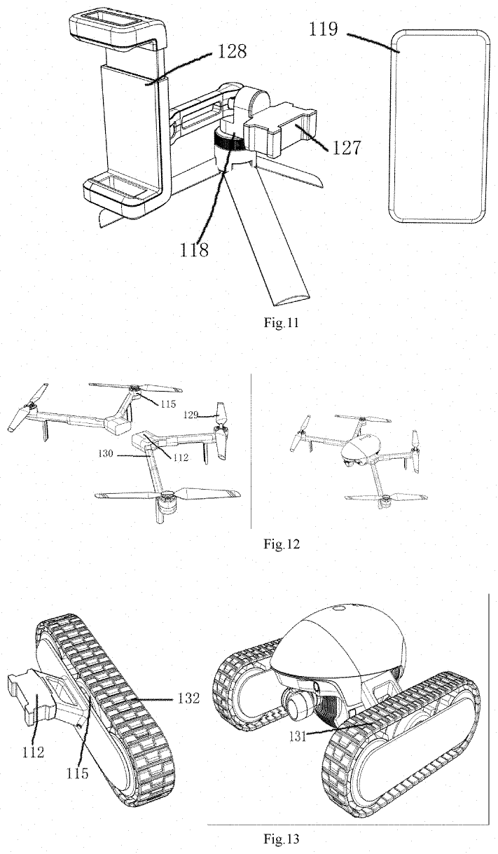

FIG. 11 is a diagram illustrating the external device of a second type according to one embodiment of the present disclosure, in which the external device includes a structural connection component 118 and an electronic connection component 119. In this example, the first interface on the body of the intelligent device includes a structural connection port and a wired or wireless interface, wherein the electronic connection component 119 is infixed or detachable connection with the structural connection component 118 via the structural connection port on the structural connection component 118, and the external device is connected with the body of the intelligent device via the first interface to form the entirety of the intelligent device. For example, when the electronic connection component 119 is a mobile phone, the structural connection component 118 is a bracket, and the body of the intelligent device is a UAV fuselage, the mobile phone is fixed on the bracket through a mobile phone holder 128 on the bracket, while the mobile phone is in wired or wireless connection with the UAV fuselage, and the bracket is connected with the UAV fuselage via the structural connection port, so that the three components are combined together to form a digital video camera (DV), which is handheld by the user via the bracket, and the camera on the UAV is controlled by the mobile phone to acquire images or videos.

In the examples of the present disclosure, the second interface on the external device is provided thereon with a swallowtail slot 127 in the embodiment of one embodiment, and the external device is in quick-release connection with the body of the intelligent device via such a swallowtail slot 127.

In one embodiment of the present disclosure, the external device is a power device, which is connected with the body of the intelligent device via the first interface, the power device comprising a power system at least comprising a motor. The power system provides power for the external device. The external device is docked with the first interface via the second interface, the second interface comprising a structural connection port and a wired interface arranged on or embedded in the second interface, or the second interface comprising a structural connection port and a wireless interface connected wirelessly with the components of the body.

The body of the intelligent device supplies power to the external device via the first interface.

The external device may also comprise a power supply battery capable of independently supplying power to the external device, and further capable of supplying power to the body of the intelligent device via the second interface and the first interface.

Further, the body comprises a motor driving circuit, through which a control instruction sent by the body controller is converted into a command capable of controlling the operation of the motor, and the command is sent to the motor to drive the same to operate. Or the external device also comprises a motor driving circuit receiving a control instruction sent by the body controller, and converting it into a command capable of controlling the operation of the motor, and the command is sent to the motor to drive the same to operate.

FIG. 12 is a diagram illustrating the external device of a third type according to one embodiment of the present disclosure, in which the external device is a UAV arm 130 that forms a completed UAV together with the UAV fuselage. The UAV arm 130 at least includes a motor and a propeller 129 arranged on the motor. A motor driving circuit is arranged on the UAV arm 130 or the UAV fuselage, to which the controller 103 on the body sends a control instruction, and through which the instruction is converted into a control command as is sent to the motor to drive the same to operate.

FIG. 13 is a diagram illustrating the external device of a fourth type according to one embodiment of the present disclosure, in which the body of the intelligent device is a UAV fuselage, and the external device is a vehicle driving device 131, together forming a completed unmanned ground vehicle (UGV). The vehicle driving device 131 at least includes a motor and wheels, or at least includes a motor and caterpillar track 132. A motor driving circuit is arranged on the vehicle driving device 131 or the UAV fuselage, to which the controller 103 on the body sends a control instruction, and through which the instruction is converted into a control command as is sent to the motor to drive the same to operate.

FIG. 14 is a diagram illustrating the external device of a fifth type according to one embodiment of the present disclosure, in which the body of the intelligent device is a UAV fuselage, and the external device is an underwater driving device 133, together forming a completed unmanned ship or submarine. The underwater driving device 133 at least includes a motor and a propeller 129. A motor driving circuit is arranged on the underwater driving device 133 or the UAV fuselage, to which the controller 103 on the body sends a control instruction, and through which the instruction is converted into a control command as is sent to the motor to drive the same to operate.

In the examples of the present disclosure, the external device 102 at least includes one or more of the structural connection component 118, the electronic connection component 119 and a device equipped with a power system. The external device 102 is connected with the body 104 of the intelligent device via the first interface 101, and various external devices 102 are connected with the body to form different intelligent devices.

The device with a power system comprises a power system comprising a motor. The power system provides power for the external device and the body of the intelligent device.

In the examples of the present disclosure, an intelligent device comprises a body of the intelligent device and an external device docked with the first interface on the body via the second interface of the external device so as to enable the quick-release connection between the external device and the body of the intelligent device. There are multiple external devices, including a first external device, a second external device, etc., and the application in a first scenario is achieved when the body is connected with the first external device, and the application in a second scenario is achieved when the body is connected with the second external device.

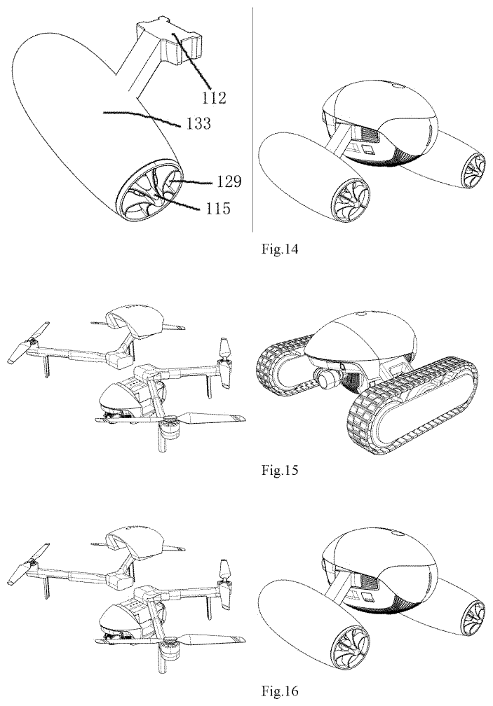

FIG. 15 is a diagram illustrating a first transformation of the external devices of the intelligent device according to one embodiment of the present disclosure, in which the body of the intelligent device is a UAV fuselage, and the external devices are a UAV arm and a vehicle driving device. The second interface on the external devices comprises a structural connection port and a wired interface. When the UAV arm is connected with the UAV fuselage by means of the docking between the second interface and the first interface, the UAV fuselage and the UAV arm are in wired connection to form a completed UAV. The UAV arm is quickly removed from the UAV fuselage, and when the vehicle driving device is connected with the UAV fuselage by means of the docking between the second interface and the first interface, the UAV fuselage and the vehicle driving device are in wired connection to form a completed UGV, thereby realizing the transformation from the UAV to the UGV. The UAV arm here at least includes a motor and a propeller, and the vehicle driving device at least includes a motor and tires, or at least a motor and caterpillar treads.

FIG. 16 is a diagram illustrating a second transformation of the external devices of the intelligent device according to one embodiment of the present disclosure, in which the body of the intelligent device is a UAV fuselage, and the external devices are a UAV arm and an underwater driving device, the second interface on the external devices comprises a structural connection port and a wired interface. When the UAV arm is connected with the UAV fuselage by means of the docking between the second interface and the first interface, the UAV fuselage and the UAV arm are in wired connection to form a completed UAV. The UAV arm is quickly removed from the UAV fuselage, and when the underwater driving device is connected with the UAV fuselage by means of the docking between the second interface and the first interface, the UAV fuselage and the underwater driving device are in wired connection to form a completed unmanned ship or submarine, thereby realizing the transformation from the UAV to the unmanned ship or submarine. The UAV arm and the underwater driving device here at least include a motor and a propeller.

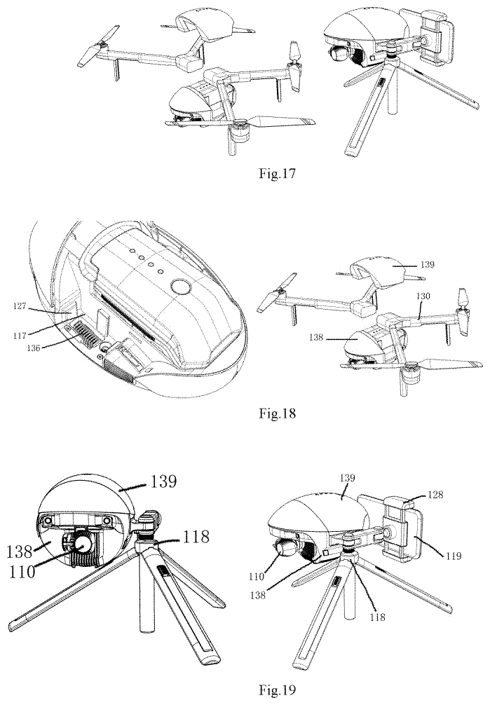

FIG. 17 is a diagram illustrating a third transformation of the external devices of the intelligent device according to one embodiment of the present disclosure, in which the body of the intelligent device is a UAV fuselage, and the external devices are a UAV arm and a bracket. When the UAV arm is connected with the UAV fuselage by means of the docking between the second interface and the first interface, the UAV fuselage and the UAV arm are in wired connection to form a completed UAV. The UAV arm is quickly removed from the UAV fuselage, and when the bracket is in quick connection with the bracket via a structural connection interface of the second interface, and meanwhile a mobile phone on the bracket is connected with the UAV fuselage via a wireless interface, a completed digital video camera (DV) is formed, thereby the transformation from the UAV to the digital video camera realized. The wireless connection here may be manual connection or automatic connection, and in the embodiment of manual connection, the user is needed to select the wireless connection with a communication module on the UAV fuselage by operating the mobile phone. When the distance between the UAV fuselage and the mobile phone is less than a predefined threshold in the embodiment of automatic connection, the mobile phone may receive wireless signals sent by the communication module on the UAV fuselage, thereby realizing the wireless connection therebetween.

In this example, when the body of the intelligent device is a UAV fuselage, the external device may comprise other devices capable to connect with the UAV fuselage via the first interface on the body, and then the transformation from the UAV to other intelligent devices may be achieved by means of the connection between the UAV fuselage and multiple different external devices.

In the example of the present disclosure, the body of the intelligent device may be other intelligent units capable of performing data processing and control, such as a bodywork of an intelligent unmanned ground vehicle.

Therefore, the examples of the present disclosure provide an intelligent device, comprising a body comprising: a first interface connected with an external device; and a controller connected with the first interface. According to the first interface and the external device, intelligent device modes include a handheld mode and a self-propelled device mode. When the intelligent device is in the self-propelled device mode, the controller is configured to control the external device.

The handheld mode refers to the intelligent device used as a handheld device which, for example, may be a handheld camera, a handheld DV, etc. When the intelligent device is in the handheld mode, the external device connected to the body of the intelligent device may include at least one of a bracket and a wristband.

The self-propelled device mode refers to the intelligent device used as a self-propelled device which, for example, may be an unmanned vehicle, a UAV, an unmanned ship, an unmanned submarine, etc. Herein, the term “self-propelled” means that a device may move, including flying in the air, travelling on the land and navigating on the water, by its own power system. When the intelligent device is in the self-propelled device mode, the external device connected to the body of the intelligent device may include at least one of a UAV arm, an underwater driving device and a vehicle driving device.

FIG. 18 is a diagram illustrating the intelligent device of a first type according to one embodiment of the present disclosure. In this example, the intelligent device comprises a body and an external device.

The body comprises a structural connection port 117 and a master connection contact 136.

The master connection contact 136 is arranged on the structural connection port 117 of the body.

The body is in quick-release connection with the external device via the structural connection port 117, and the master connection contact 136 on the body is in electronic connection with a slave connection contact on the external device after the body is connected with the external device via the structural connection port 117.

The master connection contact 136 is embedded in the structural connection port 117. Further, the structural connection port 117 is a swallowtail slot. The body also comprises a controller 103 electrically connected with the master connection contact 136. The body also comprises a communication module 107 connected with the controller 103. The external device comprises a power system receiving, via the slave connection contact, a control instruction sent by the controller 103. The power system comprises a motor and a motor driving circuit.

There are multiple external devices at least including one or more of a structural connection component 118, an electronic connection component 119 and a device equipped with a power system. The multiple external devices all may be in quick-release connection with the body of the intelligent device, and the body of the intelligent device maybe connected with different external devices, thereby forming different intelligent devices.

The device with a power system at least includes one or more UAV arm 130, an underwater driving device 133 and a vehicle driving device 131.

Specifically, the intelligent device is a UAV, the body is a UAV fuselage, and the external device 102 is a UAV arm 130. The UAV fuselage is provided thereon with a structural connection port 117 in the structure of a swallowtail slot, and a master connection contact 136 embedded in the structural connection port 117. The UAV fuselage is divided into a lower fuselage 138 and an upper fuselage 139, and the structural connection port 117 and the master connection contact 136 are arranged on a side of the lower fuselage 138. The structural connection port 117 is a swallowtail slot 127 which, on the side of the lower fuselage 138, corresponds to a swallowtail-shaped bayonet at the end of the UAV arm 130. The slave connection contact is arranged on the swallowtail-shaped bayonet on the arm. When the arm is clamped in the swallowtail slot 127 on the lower fuselage 138, the master connection contact 136 connects with the slave connection contact so as to ensure the electronic connection between the UAV fuselage and the arm. The upper fuselage 139 is clamped with the lower fuselage 138, so that the arm is in fixedly connection with the fuselage to prevent the UAV arm from vibration or displacement relative to the fuselage during flight. Such connection mode as clamping also makes it convenient for the user to replace the UAV arm 130 at any time.

The intelligent device may also be an unmanned ship or an unmanned submarine, then the body is an unmanned ship fuselage or an unmanned submarine fuselage or a UAV fuselage, and the external device is a driving device of the unmanned ship or the unmanned submarine, thereby together forming an unmanned ship or an unmanned submarine.

The intelligent device is an unmanned ground vehicle (UGV), the body is a UGV bodywork or a UAV fuselage, and the external device is a vehicle driving device 131, thereby forming an unmanned ground vehicle.

FIG. 19 is a diagram illustrating the intelligent device of a second type according to one embodiment of the present disclosure. In this example, the intelligent device comprises a body and an external device.

The body comprises a structural connection port and/or a wireless interface or a wired interface.

The body is in quick-release connection with the external device via the structural connection port, and/or the body is connected with the external device via the wireless interface or the wired interface.

The structural connection port is a swallowtail slot. The wireless interface comprises at least one of Bluetooth and WiFi. The body further comprises a controller electrically connected with the wireless interface.

The external device comprises a structural connection component 118 and/or an electronic connection component 119. The body forms different intelligent devices by means of connection with the structural connection component 118 and/or the electronic connection component 119. The structural connection component 118 is in quick-release connection with the body to form an intelligent device. Alternatively, the structural connection component 118 is in quick-release connection with the body, the electronic connection component 119 is in quick-release connection to the structural connection component 118, and the body is connected with the electronic connection component 119 via the wireless interface to form an intelligent device. Alternatively, the body is connected with the electronic connection component 119 via the wireless interface or the wired interface to form an intelligent device.

When the external device is an electronic connection component 119, and a distance value between the body and the external device 102 is less than a predefined threshold, automatic connection is established between the body and the external device via the wireless interface 116 or the wired interface 113.

The external device is a human-computer interaction device that establishes connection with the body manually or automatically.

Specifically, the body of the intelligent device is a UAV fuselage with a camera 110, and the external device is a structural connection component 118 that may be handheld. The UAV fuselage is divided into a lower fuselage 138 and an upper fuselage 139. The structural connection port that is a swallowtail slot is arranged on a side of the lower fuselage 138. The swallowtail slot on the side of the lower fuselage 138 corresponds to a swallowtail-shaped bayonet at the end of the structural connection component 118. When the structural connection component 118 is clamped in the swallowtail slot of the lower fuselage 138, the upper fuselage 139 is clamped with the lower fuselage 138 so as to together form a handheld camera, thereby preventing the structural connection component 118 from vibration or displacement relative to the fuselage during use. Such connection mode as clamping also makes it convenient for the user to replace the structural connection component 118 at any time.

Specifically, the body of the intelligent device is a UAV fuselage with a camera 110, and the external device is a structural connection component 118 that may be handheld and a mobile phone. The UAV fuselage is divided into a lower fuselage 138 and an upper fuselage 139. The structural connection port 117 that is a swallowtail slot is arranged on a side of the lower fuselage 138. The swallowtail slot on the side of the lower fuselage 138 corresponds to the swallowtail-shaped bayonet at the end of the structural connection component 118. When the structural connection component 118 is clamped in the swallowtail slot of the lower fuselage 138, the upper fuselage 139 is clamped with the lower fuselage 138, and the mobile phone is fixedly connected to the structural connection component 118 via a holder 128 at the same time, so that the mobile phone is connected with the UAV fuselage via the wireless interface or the wired interface, thereby together forming a handheld digital video camera. Such connection mode as clamping also makes it convenient for the user to replace the external device at any time.

Specifically, the body of the intelligent device is a UAV fuselage, and the external device is a mobile phone connected with the UAV fuselage via the wireless interface or the wired interface to control the UAV to fly or shoot pictures.

Through the above manners, the UAV may be easily and fast transformed into various intelligent devices to meet the usage requirements in different scenes.

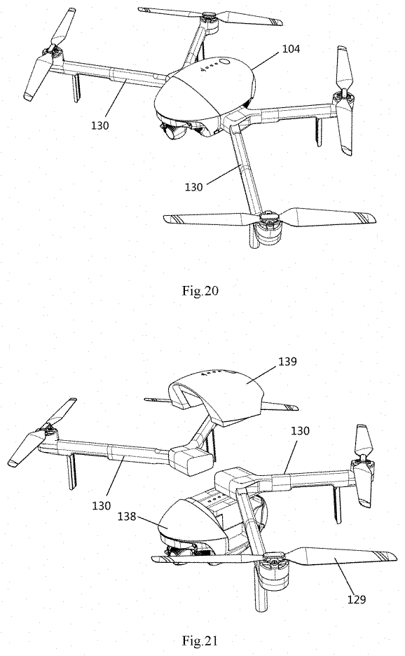

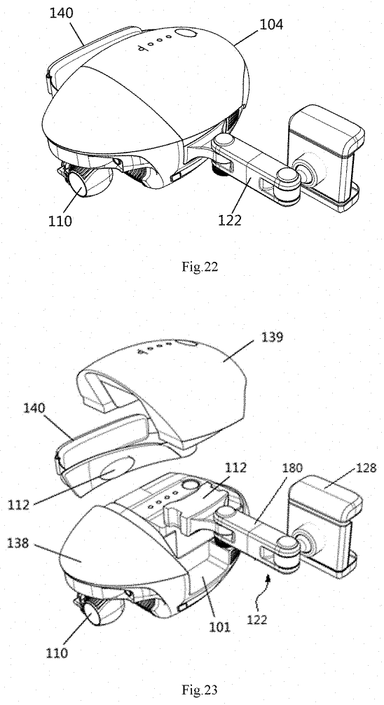

FIG. 20 is an assembly diagram of an intelligent device according to one embodiment of the present disclosure in the mode of a UAV product. FIG. 21 is an exploded view of the components of the intelligent device according to one embodiment of the present disclosure in the mode of a UAV product. FIG. 22 is an assembly diagram of an intelligent device according to one embodiment of the present disclosure in the mode of a handheld DV product. and FIG. 23 is an exploded view of the components of the intelligent device according to one embodiment of the present disclosure in the mode of a handheld DV product.

In this example, the intelligent device comprises a body 104, a UAV arm 130 and a bracket 122. The body 104 comprises a first interface 101 for alternatively connecting the UAV arm 130 or the bracket 122. The first interface 101 may be in a slot structure, a hole structure, a snap structure, etc., which is not limited by the present disclosure.

When the intelligent device is used as a UAV, the UAV arm 130 is mounted on the first interface 101. When the intelligent device needs to be used as a handheld device or a monitoring device, the UAV arm 130 may be removed from the first interface 101 and replaced with the bracket 122.

The bracket 122 may be a handheld bracket or a fixed bracket. When the bracket 122 is a handheld bracket, the user may hold the intelligent device by holding the bracket 122. The handheld bracket, for example, may include a handle or a holding rod. When the bracket 122 is a fixed bracket, the intelligent device may be supported on the ground or table top through the bracket 122. For example, the fixed bracket may comprise a tripod.

As shown in FIGS. 6, 8 and 10, the bracket 122 comprises a support part 124 and a second interface 112. The support part 124 is in fixed connection or rotational connection with the second interface 112, the support part 124 is a cylindrical handheld structure or a triangular support structure bifurcated at a lower portion, and the top of the support part 124 is rotationally connected with the second interface 112 via a rotating shaft 125. The bracket 122 is connected with the body 104 with a camera, so that the UAV may be transformed into a handheld camera or a fixed camera for use.

In addition to the handheld bracket and the fixed bracket as described above, the bracket 122 may also be a bracket of another type, which is not limited by the present disclosure. In one embodiment, the bracket 122 may be an ordinary bracket without handholding function or supporting function.

Further, the intelligent device may also comprise an electronic connection component 119 in quick-release connection to the bracket 122.

When the electronic connection component 119 needs to be mounted on the body 104 of the intelligent device, the UAV arm 130 may be removed from the first interface 101 and replaced with the bracket 122, then the electronic connection component 119 is mounted on the bracket 122, the electronic connection component 119 is in communication with the body 104 by a close distance, and the body 104 transmits in real time a captured image to the electronic connection component 119 for display, so as to set the intelligent device into the mode of a handheld DV product. In this way, the intelligent device may be switched between various product modes, expanding the function of the intelligent device and meeting the diverse needs from users.

The connection between the body 104 and the electronic connection component 119 maybe established by wired or wireless means. The electronic connection component 119 may be a mobile phone, and the wireless connection here may be manual docking or automatic docking. In the embodiment of manual docking, the user needs to select the wireless connection with a communication module on the body 104 of the intelligent device by operating the mobile phone. When the distance between the body 104 of the intelligent device and the mobile phone is less than a predefined threshold in the embodiment of automatic docking, the mobile phone may receive wireless signals sent by the communication module on the body 104 of the intelligent device, thereby establishing the wireless connection therebetween. The mobile phone may be fixed on the bracket through a mobile phone holder 128 on the bracket.

In this example, the intelligent device comprises two UAV arms 130, the body 104 comprises two first interfaces 101, and the intelligent device further comprises a wristband 140. The two first interfaces 101 are symmetrically arranged on both sides of the body 104, of which one first interface 101 is used to alternatively connect the UAV arm 130 or the bracket 122, and the other is used to alternatively connect the UAV arm 130 or the wristband 140.

When the intelligent device is used as a UAV, the two UAV arms 130 are mounted on the two first interfaces 101 respectively. When it is needed to switch the intelligent device to a handheld DV mode, the two UAV arms 130 may be removed from the first interfaces 101, then the bracket 122 for fixing the electronic connection component may be mounted on one first interface 101, and the wristband 140 may be mounted on the other first interface 101 to set the intelligent device into the handheld DV product mode.

As shown in FIG. 23, the bracket 122 comprises a second interface 112 for connecting with the first interface 101, and a holder 128 for gripping the electronic connection component 119, the holder 128 being connected to the second interface 112.

As shown in FIG. 23, further, the bracket 122 may also comprise a connecting rod 180 having one end rotatably connected with the second interface 112 and the other end rotatably connected with the holder 128. In this way, the position and angle of the electronic connection component 119 relative to the body 104 may be flexibly adjusted.

The structure of the UAV arm 130 in the example of the present disclosure will be described in detail below.

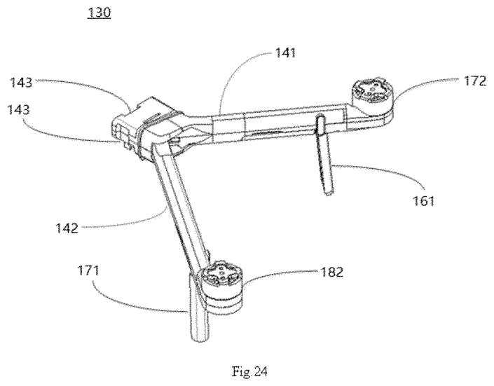

FIG. 24 shows a UAV arm 130 according to a first example of the present disclosure. As shown in FIG. 24, the UAV arm comprises a first arm 141 and at least one second arm 142. Among them, the second arm 142 is hinged with the first arm 141 via a damping component 160 (as described in detail later) and may rotate between an unfolded state and a folded state. FIG. 24 exhibits an unfolded state. In the embodiment that the second arm 142 is in an unfolded state relative to the first arm 141, as shown in FIG. 24, by overcoming a damping force of the damping component 160, the second arm 142 may be enabled to rotate towards the first arm 141 (as rotating counterclockwise in FIG. 24) and get into the folded state. In the folded state, the second arm 142, for example, is approximately close to and parallel to the first arm 141. At the time of storing the UAV arm 130, by setting the second arm 142 into the folded state, the volume of the UAV arm 130 may be greatly reduced to meet the demand for lower space occupation.

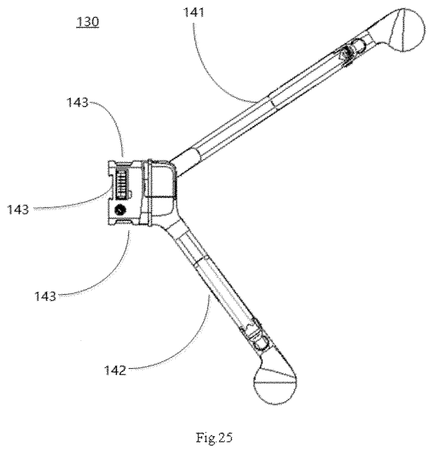

As shown in FIG. 24, in order to facilitate the assembly and connection between the UAV arm 130 and the body 104 of the intelligent device, a first slot 143 may be arranged on a side of the first arm 141. The first slot may be in the form of a swallowtail slot, so that the UAV arm 130 and the body 104 of the intelligent device may be easily assembled by inserting a swallowtail-shaped insert on the body 104 of the intelligent device into the first slot 143, and they may be disassembled easily. As shown in FIGS. 24 and 25, the three sides of the first arm 141 (i.e., a first side, a second side and a third side respectively) are provided with the first slot 143 respectively. A person skilled in the art may understand that the present disclosure is not limited to this, namely that the first slot 143 may be arranged only on one of the sides, or on two of the sides.

FIG. 26 shows the connection relation between the body 104 of the intelligent device and the UAV arm 130. As shown in FIG. 26, three swallowtail-shaped inserts 144 are arranged on the body 104 of the intelligent device, their positions correspond to the three first slots 143 on the first arm 141 of the UAV arm 130 respectively, and the shapes complement each other, so that the body 104 of the intelligent device and the UAV arm 130 may be conveniently connected and disassembled.

A person skilled in the art readily understands that a swallowtail-shaped insert may also be arranged on a side of the first arm 141, and a swallowtail slot is arranged on the body 104 of the intelligent device. Alternatively, a swallowtail-shaped insert and a swallowtail slot may be arranged on the sides of the first arm 141 respectively, and a swallowtail slot and a swallowtail-shaped insert may be correspondingly arranged on the body 104 of the intelligent device, all of which are within the protection scope of the present disclosure. Certainly, the first slot 143 may also be shaped otherwise.

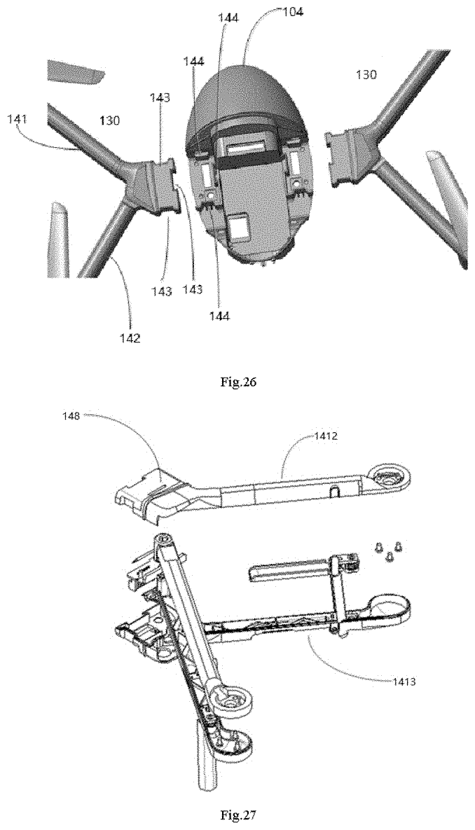

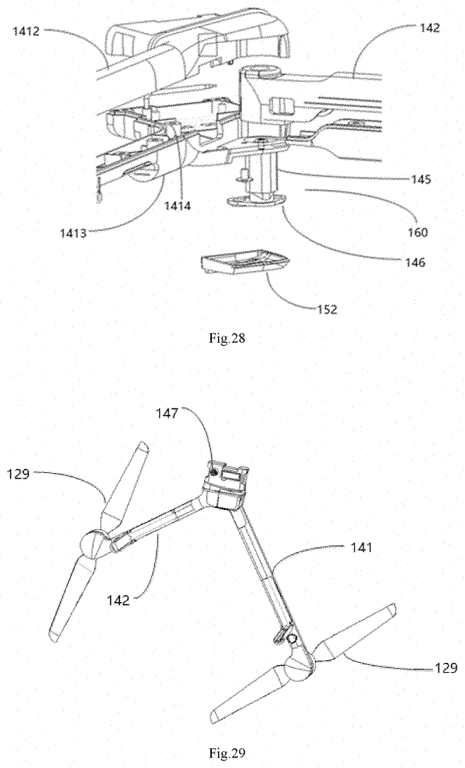

FIGS. 27 and 28 show exploded views of the UAV arm 130 respectively. As shown in FIG. 27, the first arm 141 comprises an upper cover 1412 and a lower cover 1413, both of which are connected together by, for example, bolts, thereby facilitating disassembly and assembly.

As shown in FIG. 28, at least one protrusion 1414 is arranged inside the lower cover 1413, a threaded hole is arranged in the middle of the protrusion 1414, and a threaded hole may also be arranged at a position on the upper cover 1412 corresponding to the protrusion. The upper cover 1412 and the lower cover 1413 maybe connected together just by passing a screw through the threaded hole of the upper cover and the protrusion 1414.

FIG. 29 shows a view of the UAV mechanism 130 as viewed from below. As shown in FIG. 29, the first arm 141 is provided thereon with at least one aperture 147, for example, an aperture for an electronic connection interface, including an antenna interface and a circuit connection interface. As shown in FIG. 29, a propeller 129 and a motor (as described below) are provided on both the first arm 141 and the second arm 142. The motor needs electricity to drive the propeller 129. For this purpose, the motor, for example, may receive power from a battery on the body 104 of the intelligent device via the circuit connection interface in the aperture 147 so as to drive the propeller. In addition, the circuit connection interface may also comprise a control interface. For example, the controller on the body 104 of the intelligent device may control the rotational speed, angle and other parameters of the propeller 129 via the control interface so as to control the moving direction, altitude, velocity and other motion parameters of the UAV.

According to one embodiment of the present disclosure, the upper cover 1412 of the first arm 141 is provided with a second slot 148. As shown in FIG. 27, the second slot 148 is, for example, a small strip-shaped groove, the function of which is that after the arm is clamped into the lower part of the fuselage via the first slot 143, the upper fuselage 139 has a protrusion corresponding to the second slot 148, and then the upper body 139 is combined with the lower body 138 and then is just clamped into the second slot to ensure that the arm will not shake during flight.

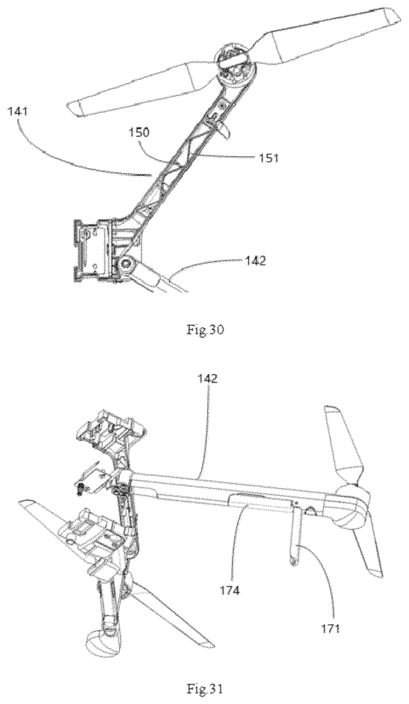

FIG. 30 shows an enlarged view of the first arm 141, in which the upper cover 1412 of the first arm 141 is removed in order to show the internal structure of the first arm 141. As shown in FIG. 30, at least one reinforcing component is arranged inside the first arm 141 to increase the structural strength of the first arm 141. As shown in FIG. 30, the reinforcing component comprises, for example, transverse baffles 150 and lateral baffles 151 between the inner walls of the first arm 141. With the transverse baffles 150 and the lateral baffles 151 may the structural strength of the first arm 141 be effectively improved, meanwhile, the first arm 141 remains substantially a hollow structure, light in weight, thereby helping to reduce the flight load.

The structure of the first arm 141 has been described in detail above, for example, comprising an upper cover and a lower cover, as well as a reinforcing component inside the same. Similar to the first arm 141, the second arm 142 may also include an upper cover and a lower cover provided with at least one protrusion. Screw holes are arranged in the center of the protrusion and a position of the upper cover corresponding to the protrusion, so that the upper cover and the lower cover are connected via bolts. The lower cover and the upper cover are connected by bolts, and at least one reinforcing component may also be arranged inside the second arm 142 to increase the structural strength of the second arm, for example transverse baffles and lateral baffles between the inner walls of the second arm 142. No more description will be made here.

A detailed structure of the damping component 160 will be described below referring to FIG. 28. As shown in FIG. 28, the damping component 160 comprises a damping shaft 145 and a fixed plate 146. A plurality of connecting holes are arranged on the fixed plate 146. The damping shaft 145 is fixedly arranged on the fixed plate 146, and the bolt or screw passes through the connecting hole of the fixed plate 146 so as to fix the fixed plate 146 to the first arm 141. The damping shaft may be a damping component in the prior art, capable of providing a certain amount of damping force. The damping shaft 145 is fixedly arranged on the first arm 141, and has one end engaged with the second arm 142, so that the second arm 142 may rotate relative to the first arm 141 when a certain pressure is applied externally enough to overcome the damping force of the damping shaft 145. The damping shaft is mounted with a certain preloading angle for the purpose of compensating for the gap caused by such mounting. The damping force predetermined in the damping shaft may overcome such problems as arm retreat caused by motor vibration so as to maintain the working state. The arm, when being stored, is manually rotated to overcome the maximum damping force and then may get into the storage state. A specific structure of the damping shaft 145 will not be described in detail here.

In addition, the damping component 160 may also comprise a cover plate 152 for covering the fixed plate 146, thereby fitting the recess of the first arm 141 to cover the fixed plate 146 and the damping shaft 145. Furthermore, as viewed from the outside, the surface of the first arm 141 is smooth, and this is conducive to improving the aesthetics and safety thereof.

A second example of the present disclosure relates to a UAV arm, which will be described below referring to the accompanying drawings.

As shown in FIG. 24, the UAV arm 130 comprises a first arm 141 and a second arm 142. The second arm 142 is hinged with the first arm 141 via a damping component 160, so that the second arm 142 may rotate towards the first arm 141 by overcoming the damping force of the damping component 160 when the second arm 142 is in an unfolded state relative to the first arm 141. In addition, the first arm 141 is provided thereon with a UAV unipod 161, and the second arm 142 is provided thereon with a UAV unipod 171.

The UAV unipods 161 and 171 are preferably capable of rotating relative to the first arm 141 and the second arm 142 of the UAV to be unfolded or folded. For example, the UAV unipods 161 and 171, when unfolded, become perpendicular to the first arm 141 and the second arm 142 and are in one plane with them, while the UAV unipods 161 and 171, when folded, may be embedded in the first arm 141 and the second arm 142.

FIG. 31 shows a second unipod 171. As shown in FIG. 31, the second arm 142 has at the lower end thereof a recess 174 having a length approximately the same as that of the second unipod 171, for example. As shown in FIG. 31, the second unipod 171 is in an unfolded position. When the second unipod 171 rotates clockwise in the figure, it may be folded and embedded into the second arm 142. The folding mode of the first unipod 161 is similar to that of the second unipod 171, and no more description will be made here.

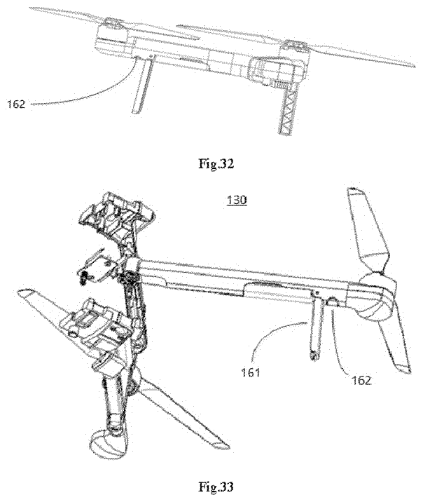

The folding mechanism and folding operation of the first unipod 161 will be described below referring to FIGS. 32-36.

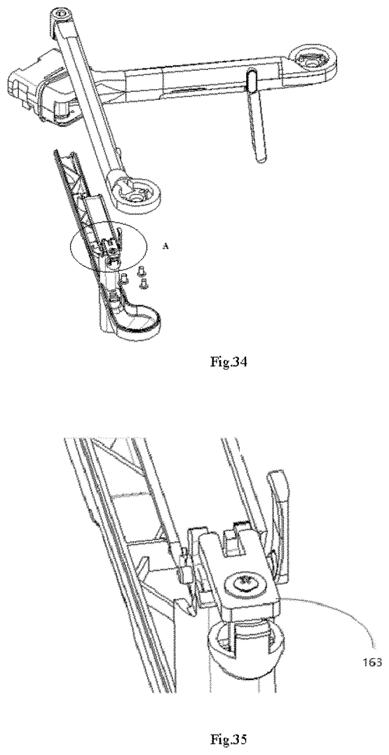

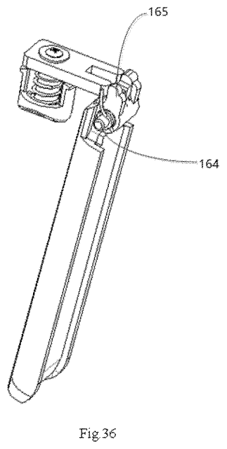

Among them, FIG. 32 is a perspective view of the UAV arm 130. FIG. 33 is an exploded view of the UAV arm 130; FIG. 34 is an exploded view of the UAV arm 130 at another angle; FIG. 35 is an enlarged view of the circle area A in FIG. 34. and FIG. 36 is a perspective view of a retractable component.

The UAV arm 130 also comprises a switch component comprising a button 162 located on the arm as shown in FIGS. 32 and 33. After the button 162 is pressed, the first unipod 161 may retract automatically. The switch component further comprises an internal first movable component 163. The UAV arm 130 further comprises a retractable component comprising an elastic shaft 164 and a second movable component 165. After the button 162 is pressed, the first movable component 163 is driven to move to release the restriction on the second movable component 165 of the retractable component, and the first unipod 161 is driven to retract by means of the elastic force of the elastic shaft 164 of the retractable component.

The switch component may control the UAV unipod to unfold and retract. The retractable component may automatically retract the unipod after the switch component is actuated, so that the unipod is embedded in the UAV arm.

The switch component comprises an elastic component and a first movable component. The retractable component comprises an elastic shaft and a second movable component. The elastic component is connected with the first movable component to drive the first movable component to move. The second movable component and the unipod bracket being sleeved on the elastic shaft, after the first movable component moves under the drive of the elastic component, and after the first movable component and the second movable component are disconnected from contact, the elastic shaft drives the unipod bracket to retract automatically. The elastic component comprises a spring and a key. The spring is in fixed connection with the key, and the switch component is controlled by pressing the key.

The folding mechanism and folding operation of the second unipod 171 are similar to those of the first unipod 161, and no more detailed description will be made here.

A third example of the present disclosure relates to a UAV arm. The description will be made below referring to the accompanying drawings.

As shown in FIG. 24, the UAV arm 130 comprises a first arm 141 and a second arm 142. The second arm 142 is hinged with the first arm 141 via a damping component 160, so that the second arm 142 may rotate towards the first arm 141 by overcoming the damping force of the damping component 160 when the second arm 142 is an unfolded state relative to the first arm 141. Among them, the first arm 141 and the second arm 142 are provided at one end thereof with a first motor 172 and a second motor 182 in fixed connection thereto, respectively.

In addition, the first motor 172 and the second motor 182 are respectively provided thereon with propellers 129 in quick-release connection to the first motor 172 and the second motor 182 via a propeller clamp (as described below).

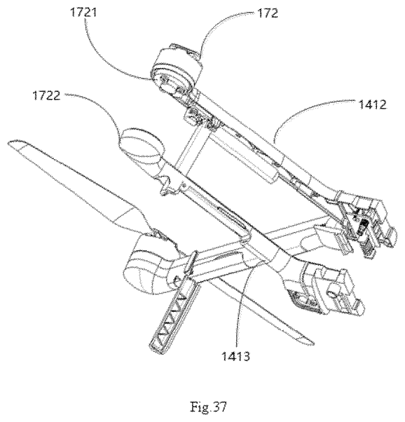

FIG. 37 shows a clearer exploded view of the first motor 172. As shown in FIG. 37, the first motor 172 comprises a fixed tray 1722 and a motor body 1721. The fixed tray 1722 is connected with the lower cover 1413 of the first arm 141 and is connected with the bottom portion of the motor body 1721. A plurality of screw holes are arranged on the fixed tray 1722 for connection with the arm. The motor body 1721 is connected with an arm screw via the fixed tray 1722. Further preferably, as shown in FIG. 37, the motor body 1721 is connected with the upper cover 1412 of the first arm.

The structure and installation of the first motor 172 have been described in detail above. The structure and installation of the second motor 182 are similar to those of the first motor 172, and no more description will be made here.

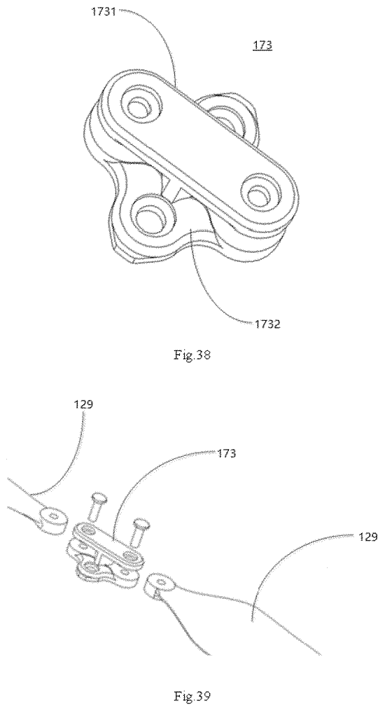

FIG. 38 shows a perspective view of a propeller clamp 173. As shown in FIG. 38, the propeller clamp 173 comprises a l-shaped upper propeller cover 1731 and a cruciform lower propeller cover 1732, both of which are connected via a central column. Both ends of the l-shaped upper propeller cover 1731 and the four corners of the cruciform lower propeller cover 1732 are provided with through holes, and through holes at both ends of the l-shaped upper propeller cover correspond to one through hole on the cruciform lower propeller cover, respectively.

FIG. 39 shows the connection mode between the propeller clamp 173 and the propeller 129. As shown in FIG. 39, a through hole is provided at the hub of the blade root of the propeller 129. A pin shaft passes through the through holes of the upper propeller cover, the lower propeller cover and the blade, so that the propeller is connected with the propeller clamp.

In addition, the first motor and the second motor are provided thereon with a slot suitable for the propeller clamp to ensure the smooth connection between the propeller clamp and the motor.

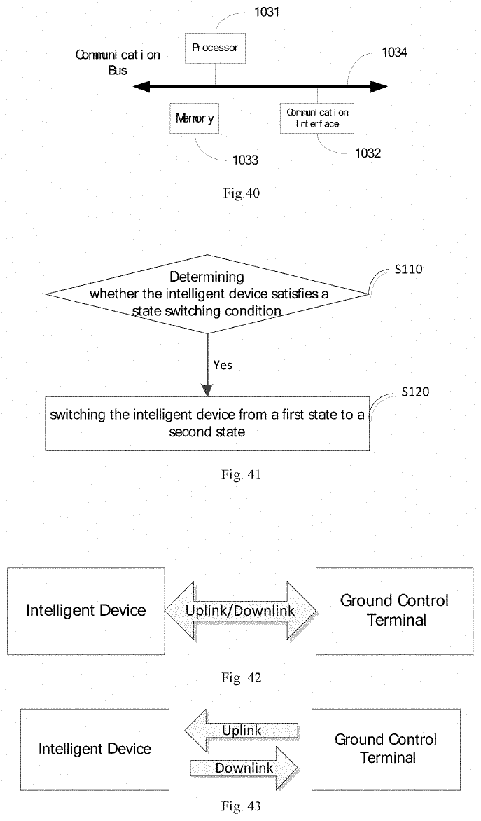

Please refer to FIG. 40 that is a structural schematic diagram of the internal components of the body of the intellectual device according to one embodiment of the present disclosure, in which the controller of the body may comprise at least one processor 1031, e.g., a CPU, at least one communication interface 1032, at least one memory 1033, and at least one communication bus 1034 for enabling the direct connection communication among these components. Among them, the communication interface 1032 of the device in the example of the present disclosure is used for signaling or data communication with other node devices. The memory 1033 may be a high-speed RAM memory, or may be a non-volatile memory, e.g., at least one disk memory. The memory 1033 may optionally be at least one storage device located away from the aforementioned processor. Computer readable instructions being stored in the memory 1033, when the computer readable instructions are executed by the processor 1031, the intelligent device performs the method or process as shown in FIG. 41 below.

Please refer to FIG. 41 that shows a flowchart of a switching method provided by the example of the present disclosure. The method may be applied to the aforesaid intelligent device, comprising the following steps:

Step S110: determining whether the intelligent device satisfies state switching conditions.

In the example of the present disclosure, the intelligent device maybe applied to a variety of application scenarios. In order to meet different application scenarios, the intelligent device may implement state switching. For example, when the intelligent device is shooting in flight, it is switched to a flight shooting state; when the intelligent device is shooting on the ground, it is switched to a ground shooting state; and when the intelligent device is used as a monitoring device, it is switched to a monitoring state.

When the intelligent device performs state switching, aground control terminal may send to the intelligent device a state switching instruction for instructing the intelligent device to switch from a current state to a target state, and after the intelligent device receives the state switching instruction, it may be determined that the intelligent device satisfies the state switching conditions. Alternatively, because the change of state may cause the data as is detected by the intelligent device per se to be different, the intelligent device may also self-detect whether the state switching conditions are met. For example, when the intelligent device detects that the current state is ground shooting, this indicates that the state switching conditions are met at this time, and then the intelligent device may be automatically switched to the ground shooting state; or when the intelligent device detects that the current state is flight shooting, this indicates that the state switching conditions are met at this time, and then the intelligent device may be automatically switched to the flight shooting state.

When the state switching conditions are met, step S120 is performed.

Step S120: switching the intelligent device from a first state to a second state.

When the intelligent device satisfies the state switching conditions, the intelligent device may be switched from the first state to the second state, so that the intelligent device may operate in the second state, thereby enabling the intelligent device to be switched to a state required by one of diverse application scenarios to allow the intelligent device to be applicable to a variety of application scenarios.

As an example, the state parameter of the intelligent device varies with the state, i.e., the switching of the intelligent device from the first state to the second state may be the switching of the state parameters, to be more specific, a first state parameter of the intelligent device in the first state is switched to a state parameter of the same in the second state at the time of controlling the intelligent device to switch from the first state to the second state.

Among them, the following several embodiments exist in the switching between the state parameters:

Embodiment I: a first bandwidth of an image transmission module of the intelligent device in the first state is switched to a second bandwidth in the second state.

Among them, the image transmission module is used by the intelligent device to transmit images to the ground control terminal. The image transmission module may be a wireless-fidelity (WiFi) image transmission module, a 5.8G wireless image transmission module, etc.

In order to implement the application of the image transmission module in various states, the bandwidth of the image transmission module may vary with the state. For example, when a distance between the intelligent device and the ground control terminal is close, then the intelligent device is in the first state, and the bandwidth of the image transmission module may be relatively higher, so that the image transmission module may be directly connected to the ground control terminal; and when a distance between the intelligent device and the ground control terminal is far, then the intelligent device is in the second state, and the bandwidth of the image transmission module may be relatively lower, so as to ensure the long-distance communication between the intelligent device and the ground control terminal.

Alternatively, when the intelligent device transmits a large image, it is then in the first state, and the bandwidth of the image transmission module may be set to be larger; and if the image transmitted by the intelligent device is small, then the intelligent device may be in the second state, and the bandwidth of the image transmission module may be adjusted to be smaller.

It may be understood that the image transmission module may have different bandwidths in different states, and the bandwidth in each state may be preset. When the intelligent device is switched from the first state to the second state, and if this involves an adjustment to the bandwidth of the image transmission module, then the bandwidth of the image transmission module just may be switched correspondingly.

Embodiment II: a first transmit power of the image transmission module of the intelligent device in the first state is switched to a second transmit power in the second state.

For example, when a distance between the intelligent device and the ground control terminal is close, then the intelligent device is in the first state, and the transmit power of the image transmission module maybe relatively lower, so that the image transmission module may be coupled with the ground control terminal at a close distance and reduce wireless radiation; and when a distance between the intelligent device and the ground control terminal is far, then the intelligent device is in the second state, and the transmit power of the image transmission module may be relatively higher, so as to ensure the long-distance communication between the intelligent device and the ground control terminal.

Alternatively, when the intelligent device transmits a large image, it is then in the first state, and the transmit power of the image transmission module may be set larger; and if the image transmitted by the intelligent device is small, then the intelligent device maybe in the second state, and the transmit power of the image transmission module may be adjusted to be smaller.

It may be understood that the image transmission module may have different transmit power in different states, and the transmit power in each state may be preset. When the intelligent device is switched from the first state to the second state, and if this involves an adjustment to the transmit power of the image transmission module, then the transmit power just needs to be switched correspondingly.

Embodiment III: a first brightness of an indicator lamp on the intelligent device in the first state is switched to a second brightness in the second state.

The indicator lamp on the intelligent device may be used to display at different degrees of brightness in different states. For example, the brightness of the indicator lamp may be lower if the intelligent device is in normal operation; and if some component of the intelligent device is in failure, the brightness of the indicator lamp may be adjusted to be higher, so that the staff may easily notice the failure and further take timely measures.

Alternatively, multiple indicator lamps may be arranged on the intelligent device, and different states may be represented by different combined brightness of indicator lamps. For example, assuming that there are 3 indicator lamps on the intelligent device, all 3 indicator lamps may be ON in the flight shooting state, only 2 indicator lamps need to be ON in the ground shooting state, and only 1 indicator lamp needs to be ON in other shooting states. Certainly, the above is exemplary only, and other brightness combinations may be further employed to represent different states in practical application.

Embodiment IV: a first color of the indicator lamp on the intelligent device in the first state is switched to a second color in the second state.

In order to identify various states of the intelligent device, each state may also be represented by setting the color of the indicator lamp, i.e., the color to be displayed by the indicator lamp of the intelligent device varies with the state. For example, the indicator lamp is in green in the flight shooting state, and the indicator lamp is in red or any other color in the ground shooting state. Alternatively, multiple indicator lamps may be arranged on the intelligent device, and the indicator lamps may display different color combinations in different states. For example, assuming that there are 3 indicator lamps, the 3 indicator lamps are displayed in a “red-green-red” combination in the flight shooting state, while the 3 indicator lamps are displayed in a “red-red-yellow” combination or only two of them are displayed, for example only two indicator lamps are displayed in two colors as “red-yellow”, in the ground shooting state. Certainly, the above is exemplary only, and other color combinations may be further employed to represent different states in practical application.

In addition, the embodiments as listed above are only those possible embodiments of switching of the state parameters. The practical application may further involve switching of other state parameters, such as switching of power, switching of camera parameter, switching of communication parameter and others. Certainly, there may also be other switching than the state parameters, for example switching of antennas. The embodiments of communication parameters and antenna switching will be described below.

Embodiment V: a first communication parameter of the intelligent device in the first state is switched to a second communication parameter of the intelligent device in the second state.

Among them, at the time of uplink transmission of data to the intelligent device (i.e., the ground control terminal transmits data to the intelligent device), this is mainly directed to control signals, while the data volume is small, so data stability, communication distance, penetration ability and diffraction ability need to be better guaranteed in the uplink transmission of data; and at the time of downlink transmission of data from the intelligent device (i.e., the intelligent device transmits data to the ground control terminal), this mainly involves image data, and the clearer the images, the better, so greater data throughput is needed during the downlink transmission of data.

Generally, the wireless communication links of an intelligent device are designed to be symmetrical, i.e., the uplink transmission and the downlink transmission employ the same wireless communication mode (i.e., using the same communication link), as shown in FIG. 42, using the same communication protocol, including frequency division multiplexing, time division multiplexing, etc.; furthermore, the compatibility between coverage and data throughput capacity needs to be taken into account if the same communication link is employed.

But an asymmetric communication protocol structure may be adopted in one embodiment of the present disclosure. As shown in FIG. 43, different wireless communication modes are used between the intelligent device and the ground control terminal, which may satisfy the demands for different data communication characteristics in uplink transmission and downlink transmission. The uplink transmission particularly takes such advantageous measures in long-distance communication as are strong in penetration ability and diffraction ability, and the downlink transmission uses large-rate and high-stability transmission that satisfies image transmission.

Among them, the uplink data communication uses a frequency band less than 1 GHz, and the wireless signal is low in frequency, long in wavelength, strong in the ability to bypass obstacles, and larger in signal coverage in the same communication environment. The uplink data communication adopts a data modulation mode with lower frequency, and the simpler the modulation mode, the lower the receiving sensitivity of the device, and the larger the signal coverage in the same communication environment. While the downlink data communication uses a frequency band of 2.4 GHz or 5 GHz, and the wireless signal is high in frequency and short in wavelength; good communication requires an unobstructed distance, and a good sight distance from the sky to the ground. The downlink data communication adopts a higher-rate data modulation mode, and the more complex the modulation mode, the higher the receiving sensitivity of the device, and the stronger the data throughput capacity in the same communication environment.

Among them, when the intelligent device needs to transmit data to the ground control terminal, the communication mode may be switched to the downlink communication mode, and when the ground control terminal needs to transmit data to the intelligent device, the communication mode may be switched to the uplink communication mode. The communication parameters involved in the switching include signal wavelength, modulation mode, signal transmission power, receiving sensitivity and other parameters.

Embodiment VI: a first antenna of the intelligent device for transmitting and receiving signals in the first state is switched to a second antenna for transmitting and receiving signals in the second state.

For example, the first antenna may be used for signal transmission and reception in the flight shooting state, while the second antenna may be used for signal transmission and reception in the ground shooting state. Among them, the switching between the antennas is controlled by an antenna switching circuit on the intelligent device, i.e., the processor on the intelligent device generates an antenna switching instruction and controls the antenna switching circuit to switch from the first antenna to the second antenna. It may be understood that the antenna switching circuit may be a relay or a triode, and the antenna switching circuit may be used to cutoff the power supply to the first antenna and connect the second antenna with the power supply circuit, then indicating that the first antenna is disabled while the second antenna is enabled so as to complete the switching between the first antenna and the second antenna.

In addition, as an example, the intelligent device may implement the switching between shooting states, i.e., the state switching conditions include shooting state switching conditions. Therefore, when the intelligent device meets the shooting state switching conditions, the intelligent device may be switched from a first shooting state to a second shooting state.

A shooting state may refer to states for different objects to be shot. For example, when the object to be shot is a person, resolution of pixels needs to be higher in the shooting state, and bokeh may be required for shooting; and when the object to be shot is a landscape, resolution of pixels maybe set relatively lower in the shooting state, and bokeh is not required. Therefore, at the time of switching the shooting states, the corresponding shooting parameters may be switched to make them adaptive to shooting in different shooting states.

Certainly, the shooting states may also be distinguished according to the application scenario of the intelligent device. For example, the state parameters during the flight shooting and the ground shooting may also be different. For example, the indicator lamp may be turned ON during the flight shooting, and the indicator lamp may be controlled and turned off during the ground shooting; alternatively, the bandwidth of the image transmission module may be controlled to be lower during the flight shooting, and the bandwidth of the image transmission module maybe controlled to be higher during the ground shooting.

As an example, one of the first shooting state and the second shooting state may be a self-propelled shooting state, and the other may be a handheld shooting state.

Among them, the self-propelled shooting state refers to a shooting state of the intelligent device at the time of shooting while self-propelling. The self-propelled shooting state includes at least one of a flight shooting state, a land navigation shooting state and an underwater navigation shooting state.

The handheld shooting state refers to a shooting state in which a user is shooting with a handheld intelligent device. In the handheld shooting state, a terminal device may be arranged on the bracket on the intelligent device. At this time, the intelligent device is a handheld DV. Due to the short-range communication between the terminal device and the intelligent device, the intelligent device transmits in real time captured images to the terminal device for display. At this time, the external device with a power system has been removed from the intelligent device, and the user may handhold the intelligent device for shooting. The external device with a power system includes at least one of a UAV arm, an underwater driving device and a vehicle driving device.

When the intelligent device is switched from the self-propelled shooting state to the handheld shooting state, the external device with a power system may be removed from the intelligent device, i.e., it is determined that the intelligent device satisfies the shooting state switching conditions if change takes place in the connection state between the external device with a power system of the intelligent device and the body of the intelligent device.

Description will be made below by taking an example in which the self-propelled shooting state is the flight shooting state. At this time, the external device with a power system is an UAV arm.

The flight shooting state refers to a shooting state in which the intelligent device is shooting the ground from a high altitude. When the intelligent device is switched from the flight shooting state to the handheld shooting state, the UAV arm on the intelligent device may be removed, i.e., it is determined that the intelligent device meets the shooting state switching conditions if change takes place in the connection state between the UAV arm of the intelligent device and the body of the intelligent device.

It may be understood that when the intelligent device detects that the UAV arm is disconnected from the body of the intelligent device, it may automatically switch the flight shooting state to the handheld shooting state, and the switching process may specifically involve the switching between such state parameters as are listed in the above embodiments, e.g., the switching between the bandwidths of the image transmission module, the switching between the transmit powers of the image transmission module, the switching between the brightness of the indicator lamp and/or the switching between the antennas. On the contrary, when the intelligent device detects the connection between the arm and the body of the intelligent device, it may automatically switch from the shooting state to the flight shooting state, and the switching process therein also involves the switching between the parameters in the above embodiments.

For example, the bandwidth of the image transmission module may be 5 MHz/10 MHz in the flight shooting state, and when the intelligent device is switched to the handheld shooting state, the bandwidth of the image transmission module may be adjusted to 20 MHz to make the it reach the bandwidth required by the connection with a terminal device. On the contrary, at the time of switching from the handheld shooting state to the flight shooting state, the bandwidth of the image transmission module may be adjusted from 20 MHz to 5 MHz/10 MHz, thereby increasing the image transmission distance and enhancing the anti-interference ability.

Alternatively, the transmit power of the image transmission module is a normal transmit power in the flight shooting state, and at the time of switching to the handheld shooting state, the transmit power of the image transmission module may be reduced to about 8 dbm to achieve the short-range connection with a terminal device and reduce wireless radiation. On the contrary, at the time of switching from the handheld shooting state to the flight shooting state, the transmit power of the image transmission module may be switched from 8 dbm to the normal transmit power to provide the long-distance performance of connecting a remote terminal device.

Alternatively, the first antenna is used for signal transmission and reception in the flight shooting state, and the second antenna is used for signal transmission and reception in the handheld shooting state, i.e., the roundness of the radiation pattern of the first antenna is greater than that of the second antenna. Therefore, the roundness of the radiation pattern may be increased in the flight shooting state, and the greater the roundness, the smaller the signal change in all directions around the intelligent device. The first antenna may be arranged on the body of the intelligent device, and the second antenna may be arranged on the UAV arm of the intelligent device.

Alternatively, the brightness of the indicator lamp of the intelligent device is a first brightness in the flight shooting state, and the brightness of the indicator lamp is a second brightness in the handheld shooting state. Therefore, the brightness of the indicator lamp may also be adjusted from the first brightness to the second brightness at the time of switching from the flight shooting state to the handheld shooting state.

The brightness of the indicator lamp may be modulated by controlling the duty cycle of the output current to the indicator lamp by a LED driver on the intelligent device. If the first brightness is brighter than the second brightness, the duty cycle of the output current to the indicator lamp may be decreased, so that the brightness may be lowered. And in the handheld shooting state, the brightness will automatically reduce without dazzling. On the contrary, if the intelligent device is switched from the handheld shooting state to the flight shooting state, the duty cycle of the output current to the indicator may be increased.

In addition, if the handheld shooting state is different only in state parameters from the flight shooting state, the switching between the shooting state parameters may also be performed after a switching instruction is received. Among them, when it comes to the brightness of the indicator lamp, i.e., after an instruction on switching the shooting state is received, the brightness of the indicator lamp may be switched from the first brightness in the first state to the second brightness in the second state.

It shall be noted that the above switching between the shooting states may also involve switching of other state parameters. What is described above is only exemplary, and the state parameters to be switched may be set to meet the actual needs. For example, when there are multiple cameras on the intelligent device, this may also involve the switching between cameras, between powers, and between circuits.

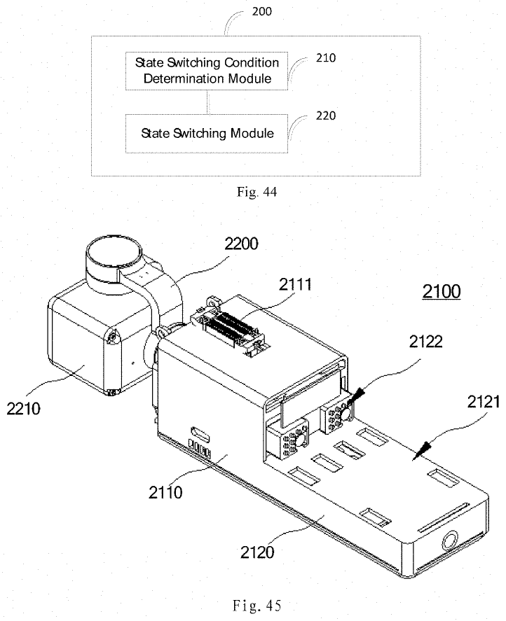

Referring to FIG. 44, a structural block diagram of a switching means 200 as is provided according one embodiment of the present disclosure, in which the means 200 may be a module, a program segment or a code on the intelligent device. It should be understood that the means 200 corresponds to the method example of FIG. 41 above, capable of performing each step involved in the method example of FIG. 41. The specific functions of the means 200 maybe found referring to the description above. For the avoidance of repetition, the detailed description will be omitted appropriately here.

Optionally, the means 200 comprises:
a state switching condition determination module 210 for determining whether the intelligent device satisfies a state switching condition;
a state switching module 220 for switching the intelligent device from a first state to a second state when the state switching condition is satisfied.

Optionally, the state switching conditions include shooting state switching conditions, and the state switching module 220 is used to switch the intelligent device from a first shooting state to a second shooting state when the shooting state switching condition is met, one of the first shooting state and the second shooting state being a flight shooting state, and the other being a handheld shooting state.

Optionally, the state switching condition determination module 210 is used to determine that the intelligent device satisfies the shooting state switching conditions if change takes place in the connection state between the arm of the intelligent device and the body of the intelligent device.

Optionally, the state switching module 220 is used to switch a first state parameter of the intelligent device in the first state to a second state parameter of the intelligent device in the second state.

Optionally, the state switching module 220 is used to switch a first bandwidth of an image transmission module of the intelligent device in the first state to a second bandwidth in the second state.

Optionally, the state switching module 220 is used to switch a first transmit power of the image transmission module of the intelligent device in the first state to a second transmit power in the second state.

Optionally, the state switching module 220 is used to switch a first brightness of an indicator lamp on the intelligent device in the first state to a second brightness in the second state.

Optionally, the state switching module 220 is used to switch a first antenna of the intelligent device for transmitting and receiving signals in the first state to a second antenna for transmitting and receiving signals in the second state.

One embodiment of the present disclosure provides a readable storage medium executing the method or process as executed by the intelligent device in the method example as shown in FIG. 41 when the computer program is executed by the processor.

This example discloses a computer program product comprising a computer program stored on a non-transient computer-readable storage medium. The computer program includes a program instruction. When the program instruction is executed by the computer, the computer may execute the methods as provided by the above method examples, for example, comprising: determining whether the intelligent device meets the state switching conditions; and switching the intelligent device from the first state to the second state when the state switching conditions are met.

### Second Aspect

The present disclosure also provides an intelligent device, which can be used in a handheld manner and can be used for flight, and can also be erected on a plane for use.

The intelligent device first comprises a handheld body (a body) 2100 (corresponding to the body 104 in the first aspect of the present disclosure) and a flight driving device (corresponding to the UAV arm 130 in the first aspect of the present disclosure). The handheld body 2100 can be connected with or separated from the flight driving device.

When the handheldbody 2100 is separated from the flight driving device, the overall size is small and can be held by a single hand so as to facilitate the use in a handheld mode.

When the handheld body 2100 is connected with the flight driving device, the flight driving device carries the handheld body 2100 to form a flyable mobile device for use in a flight device mode (corresponding to the self-propelled device mode in the first aspect of the present disclosure).

The intelligent device further comprises a support frame (corresponding to the bracket 122 in the first aspect of the present disclosure). At least the handheld body 2100 can be mounted on the support frame to form a device that can be erected on the ground or other planes for use in an erected device mode.

The intelligent device is equipped with a shooting module 2210 (corresponding to the image module 108 in the first aspect of the present disclosure) mounted on the handheld body 2100 and capable of working to collect images, videos, etc., during the use of the intelligent device whether in the handheld mode or in the flight device mode.

During the flight of the intelligent device, or in the handheld mode, the whole intelligent device when held by a user and moving may often bump or shake up and down due to movement, which easily leads to unclear imaging of the shooting module 2210. In order to improve the imaging effect, the handheld body 2100 is provided with a gimbal mechanism 2200 where the shooting module 2210 is mounted, the gimbal mechanism 2200 is used for adjusting the shooting module 2210 along with the shaking during movement so as to minimize the impact of bumping and shaking on the shooting module 2210 and maintain the shooting module 2210 stable.

When the shooting angle needs to be adjusted, the gimbal mechanism 2200 can also be used to change the shooting angle of the shooting module 2210. The gimbal mechanism 2200 can be a two-axis or three-axis gimbal. The shooting module 2210 is mounted on the same, and then the viewing angle of the shooting module 2210 is made oriented in different directions by regulating the rotation of each axis, so that images in more directions can be collected smoothly when the handheld body 2100 maintains the current state.

In other examples, the gimbal mechanism 2200 may also be used for the mounting of other devices, such as an object transport box, so as to facilitate smooth transport of goods.

A structure of the flight driving device may include a UAV fuselage forming a mounting position for the handheld body 2100, and a UAV arm 2500 mounted on the UAV fuselage.

The mounting position may be a concave cavity arranged at the bottom of the UAV fuselage (i.e., one side facing the ground during flight). The handheld body 2100 is fixed in the concave cavity of the UAV fuselage, the gimbal mechanism 2200 protrudes out of the concave cavity to move and facilitate the shooting module 2210 to collect images, and the flight driving device carries the handheld body 2100 to fly and work.

Alternatively, it may be a slot having an opening towards front of the UAV fuselage. The gimbal mechanism 2200 is arranged at one end of the handheld body 2100, and the other end of the handheld body 2100 is inserted into the slot.

To provide operation power, the intelligent device is equipped with a handheld mode battery 2300 and a flight mode battery 2400.

The flight mode battery 2400 of the intelligent device is mounted on the UAV fuselage, so the flight driving device can fly alone.

The handheld mode battery 2300 of the intelligent device is mounted at the mounting position of the handheld body 2100, so the handheld body 2100 can be used alone.

To reduce the volume of the intelligent device so as to provide a multifunctional intelligent device convenient for storage, further, the flight driving device is configured into the UAV arm 2500, and the handheld body 2100 is provided with a battery mounting position 2121 and an arm mounting position 2122 (corresponding to the structural connection port 117 in the first aspect of the present disclosure).

Namely, the flight device mode is developed when the handheld body 2100 and the battery connected thereto overall serve as the fuselage, and the UAV arm 2500 is connected to the arm mounting position 2122.

The intelligent device further comprises a connector comprising a male connector and a female connector 2123, wherein the female connector 2123 is disposed at the arm mounting position 2122 and the male connector at the UAV arm 2500.

On the female connector 2123 are integrated an arm detection interface, an arm power supply interface and a signal transmission interface, while on the male connector are arranged adapters corresponding to each interface. When the arm is connected to the arm mounting position 2122, the male connector mates with the female connector 2123, so that the UAV arm 2500 obtains operation power from the handheld body 2100 through the connector and exchanges control signals with the handheld body 2100.

At least one of the handheld mode battery 2300 and the flight mode battery 2400 is mounted at the battery mounting position 2121 of the handheld body 2100. When the handheld body 2100 works alone in the handheld mode, the handheld mode battery 2300 is mounted at the battery mounting position 2121. When it is needed to work in the flight device mode, the flight mode battery 2400 is then mounted at the battery mounting position 2121.

To improve the comfort level during hand-holding, when the handheld mode battery 2300 is mounted at the battery mounting position 2121, the handheld mode battery 2300 fills up the battery mounting position 2121 and shields the arm mounting position 2122 so as to protect the female connector 2123 of the connecter and make the handheld mode battery 2300 forma continuous handheld surface together with the handheld body 2100.

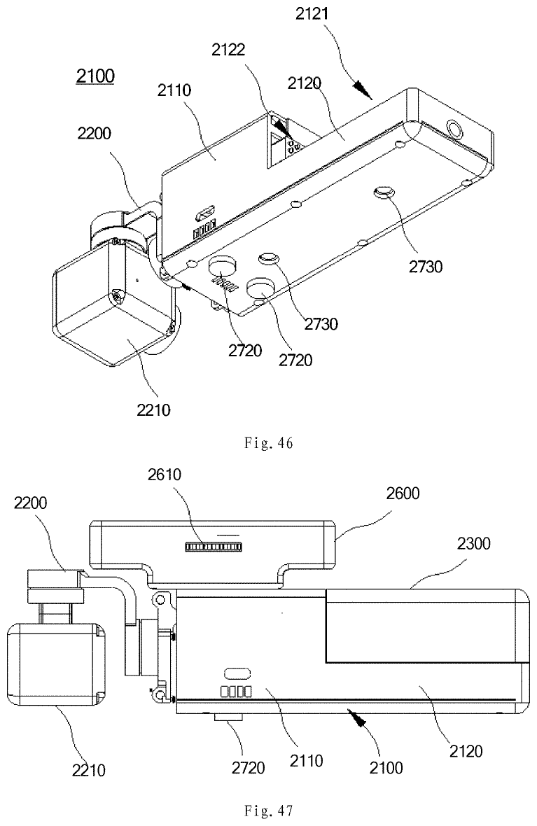

As shown in FIGS. 45 and 46, the handheld body 2100 has a stepped structure. A first step 110 retreats relative to a second step 2120, and the arm mounting position 2122 and the battery mounting position 2121 are formed on the stair face of the second step 2120, wherein the arm mounting position 2122 is close to the vertical face of the first step 110 and surrounded by the battery mounting position 2121.

The handheld mode battery 2300 is a small cuboid, which makes up the space of retraction, so as to form a large cuboid together with the handheld body 2100. Each edge of the cuboid is a rounded corner to further improve the hand-holding comfort.

When the handheld mode battery 2300 is connected with the handheld body 2100 to form the large cuboid, it provides operation power for the functional modules on the handheld body 2100, such as the gimbal mechanism 2200 and the shooting module 2210. Holding the large cuboid, the user can collect images by the shooting module 2210, adjust the shooting direction using the gimbal mechanism 2200 or maintain the shooting module 2210 stable.

To make it convenient to check the shooting effect during the handheld shooting, the intelligent device further comprises a screen module 2600. The shooting module 2210, the screen module 2600 and the gimbal mechanism 2200 are in electrical connection with the control system of the handheld body 2100.

On the stair face of the second step 2120 of the handheld body 2100 is disposed an expansion interface 2111, to which the screen module 2600 is connected, as shown in FIG. 47.

The screen module 2600 is provided with a dial wheel 2610 which can be rotated to enlarge or reduce an image on the screen module 2600 in a handheld state. The screen module 2600 is also provided with a steering key, via which the rotation of the gimbal mechanism 2200 is controlled to change the shooting angle of the shooting module 2210. The screen module 2600 displays the shooting results of the shooting module 2210 in real time.

In one example, the screen module 2600 is provided with a secondary interface, to which other devices such as a radio device and a light filling device can be connected when the screen module 2600 is connected to the expansion interface 2111.

When it is needed to operate in the flight device mode, the flight mode battery 2400 is mounted at the battery mounting position 2121. As described above, the flight mode battery 2400 forms a fuselage with the handheld body 2100, and the external shape of the flight mode battery 2400 is constructed to make way for the arm mounting position 2122, thereby enabling the arm mounting position 2122 to be exposed so that the UAV arm 2500 can be mounted. When the UAV arm 2500 is connected to the arm mounting position 2122, the intelligent device is set into the flight device mode.

The capacity of the flight mode battery 2400 is greater than that of the handheld mode battery 2300 so as to be capable of powering both the handheld body 2100 and the flight driving device at the same time, thereby increasing the duration of flight.

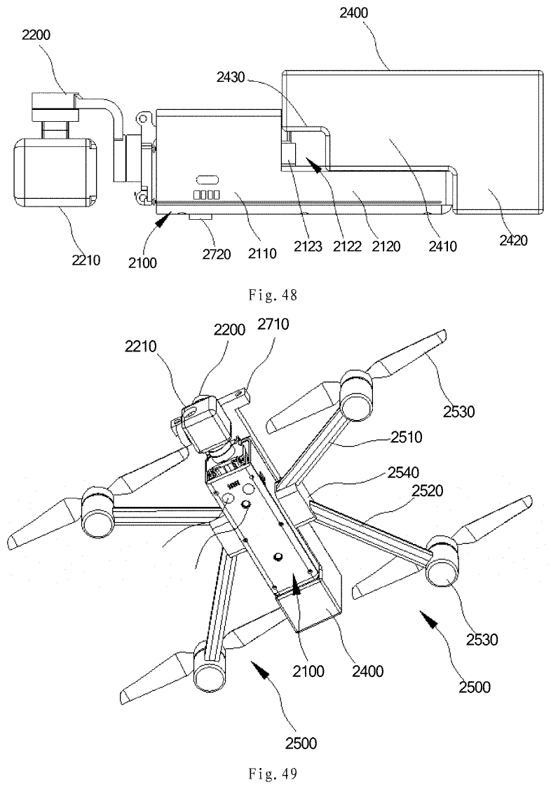

As shown in FIG. 48, the flight mode battery 2400 has a substantially stepped structure, comprising a third step 2410 and a fourth step 2420, wherein the third step 2410 matches the battery mounting position 2121, and the fourth step 2420 abuts against the vertical face of the second step 2120 of the handheld body 2100 (i.e., one end of the handheld body 2100 away from the gimbal mechanism 2200). Among them, the third step 2410 is partially concave to form a recess 2430 enclosing with the surface of the handheld body 2100 to form a socket where the arm mounting position 2122 is located.

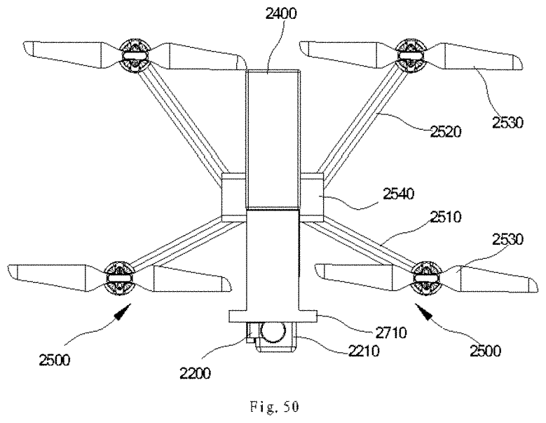

FIGS. 49 and 50 show the structural diagrams of the flight device mode. The UAV arm 2500 is mounted at the arm mounting position 2122, enabling the male connector of the UAV arm 2500 to be inserted into the female connector 2123 on the handheld body 2100, and then the flight mode battery 2400 is mounted at the battery mounting position 2121, so that the flight mode battery 2400 and the handheld body 2100 jointly limit the UAV arm 2500, and the handheld body 2100, the UAV arm 2500 and the flight mode battery 2400 together form a flyable device mode.

The flight mode battery 2400 supplies power to the handheld body 2100, and the UAV arm 2500 obtains operation power from the handheld body 2100 via the connector and exchanges control signals with the handheld body 2100.

There are two UAV arms 2500 in the left and right respectively. The intelligent device in the flight device mode may be with double rotors or multiple rotors, and it is with four rotors in this example.

Referring again to FIGS. 49 and 50, each UAV arm 2500 comprises a connecting plug 2540, a first arm 2510, a second arm 2520 and a propeller component 2530.

One ends of the first arm 2510 and the second arm 2520 are connected to the connecting plug 2540, the connecting plug 2540 is used for entering from the socket and connecting the arm mounting position 2122. The male connector of the connector as mentioned above is disposed on the connecting plug 2540. When the connecting plug 2540 is connected to the arm mounting position 2122, the male connector mates with the female connector 2123.

The other ends of the first arm 2510 and the second arm 2520 are respectively provided with a propeller component 2530. The motor of the propeller component is mounted on the UAV arm 2500, and the blades of the propeller component 2530 are mounted on the output shaft of the motor. The power supply line of the motor is routed within the UAV arm 2500 and connected to the male connector. After the UAV arm 2500 is mounted at the arm mounting position 2122, the motor can obtain operation power and receive control signals.

In one example, at least one of the first arm 2510 and the second arm 2520 can rotate relative to the connecting plug 2540. When the UAV arm 2500 is removed from the handheld body 2100, the first arm 2510 and the second arm 2520 can rotate to be parallel and close together, thereby reducing the space occupied by the overall UAV arm 2500 to facilitate storage and carrying.

During flight, the intelligent device may be so far away from the user that sometimes it is not convenient to accurately judge the environment of the device by naked eye, which then easily make the device impacted and out of control. In order to alleviate this problem, the intelligent device further comprises a sensor module, which includes a GPS positioning module, a first binocular vision sensor 2710 and a second binocular vision sensor 2720 arranged on the handheld body 2100.

The GPS positioning module is used to acquire in general the geographical location of the intelligent device, which is convenient for navigation and loss prevention. The first binocular vision sensor 2710 and the second binocular vision sensor 2720 can be used to detect the environment around the intelligent device in real time to know whether there are obstacles, and can also be used to detect and find targets.

The first binocular vision sensor 2710 is located at one end of the handheld body 2100 close to the gimbal mechanism 2200 to detect front obstacles or targets during flight.

In one example, the first binocular vision sensor 2710 may be integrated on the handheld body 2100, and a detection head thereof is arranged to protrude out of the handheld body 2100 and can rotate outside the handheld body 2100.

When the intelligent device is in the flight device mode, the detection head rotates and is oriented toward the front, namely protruding towards the direction of the gimbal mechanism 2200, and is located above the shooting module 2210. Since the shooting module 2210 generally rotates to be upwards, this position is convenient for detection and does not affect the gimbal mechanism 2200 to drive the shooting module 2210 to rotate for shooting.

When the intelligent device is in the handheld mode, the shooting of the shooting module 2210 requires omni-directional rotation for shooting. If the detection head still protrudes towards the gimbal mechanism 2200, this may affect the rotation of the gimbal mechanism 2200. Therefore, the detection head rotates to be away from the gimbal mechanism 2200 in the handheld mode.

In the intelligent device according to this example as shown in FIGS. 49 and 50, the first binocular vision sensor 2710 is arranged to be detachably connected to the handheld body 2100. In the flight device mode, the first binocular vision sensor 2710 is used to replace the screen module 2600 and is mounted on the expansion interface 2111. Since the body of the first binocular vision sensor 2710 and the detection head thereof are integrated and can be separated from the handheld body 2100, the overall volume of the handheld body 2100 is smaller, so that the smaller weight and volume of the handheld body 2100 allow the handheld body 2100 to be more portable, thereby facilitating use in the handheld mode.

The second binocular vision sensor 2720 is located at a side of the handheld body 2100. When the intelligent device flies in the air in the flight device mode, the side will face the ground so as to detect obstacles or targets below the route during flight.

As shown in FIGS. 45, 46 and 48, the battery mounting position 2121, the arm mounting position 2122 and the expansion interface 2111 are located on a first side of the handheld body 2100, the flight mode battery 2400 and the handheld body 2100 form sockets on second and third sides respectively, and the second binocular vision sensor 2720 is located on a fourth side.

The first side is parallel to the fourth side, and the second side is parallel to the third side. In the flight device mode, the first side and the fourth side are parallel to the horizontal plane, the first side is located above while the fourth side is located below; meanwhile, the second side and the third side are parallel to the vertical plane, from which the UAV arm 2500 protrudes horizontally.

It should be noted that such terms as “horizontal” and “vertical” do not mean that components are required to be absolutely horizontal or vertical, but can be slightly inclined. For example, “horizontal” only means that a direction of a structure is more horizontal than “vertical”, and does not mean that the structure must be completely horizontal, but can be slightly inclined.

In order to improve the detection effect of the second binocular vision sensor 2720 and the shooting effect of the shooting module 2210, the handheld body 2100 is also provided with a fill-in light 2730 located on the same side of the handheld body 2100 as the second binocular vision sensor.

Referring again to FIGS. 46 and 49, two fill-in lights 2730 are disposed on the fourth side of the handheld body 2100, which are close to both ends of the handheld body 2100 respectively. When the fill-in lights 2730 are turned on, conical illumination areas are formed, capable of covering the front and rear positions of the projection range of the fuselage. The two conical illumination areas overlap within the projection range of the fuselage to enhance the illumination intensity.

When it is needed to operate in the erected device mode, the handheld body 2100 is at least mounted on the support frame, and is connected with the handheld mode battery 2300 or the flight mode battery 2400 to obtain power. While the support frame is not shown in the drawings, those skilled in the art should understand that the support frame is a bracket capable of being erected and fixed on the ground, table top, and other flat or uneven surfaces, such as a tripod.

In one example, the support frame has a placement plane, which is partially concave to form a mounting groove to clamp and fix the handheld body 2100 and the battery connected thereto.

In one example, the support frame is formed with a threaded column, and at least one of the handheld body 2100, the handheld mode battery 2300 and the flight mode battery 2400 is provided with a nut capable of being thread-connected with the threaded column.

For example, the nut is formed on the handheld body 2100. As can be seen in FIG. 45, the nut is located on an end face of the handheld body 2100 away from the gimbal mechanism 2200. After the handheld mode battery 2300 is mounted, the nut of the handheld body 2100 is screwed onto the threaded column to be fixed on the support frame and operate in the erected device mode.

As one further example, the nut is formed at other positions on the surface of the handheld body 2100, so that after the flight mode battery 2400 is mounted, and when the end face of the handheld body 2100 away from the gimbal mechanism 2200 is blocked by the flight mode battery 2400, the handheld body 2100 can also connect the threaded column via the nut so as to operate in the erected device mode.

As another example, in addition to the nut disposed on the end face of the handheld body 2100 away from the gimbal mechanism 2200, a same nut is also formed on the flight mode battery 2400. When the handheld body 2100 is connected with the flight mode battery 2400, even if the end face of the handheld body 2100 away from the gimbal mechanism 2200 is blocked by the flight mode battery 2400, the nut on the flight mode battery 2400 can also be connected to the threaded column of the support frame to be mounted on the support frame and operate in the erected device mode.

The case may also be that nuts are respectively disposed on the handheld mode battery 2300 and the flight mode battery 2400. Whether the handheld body 2100 is connected with the handheld mode battery 2300 or with the flight mode battery 2400, the threaded column of the support frame can be connected with the nuts on the batteries so as to operate in the erected device mode.

Multiple interfaces are included in the second aspect of the present disclosure, including mechanical interfaces and electrical interfaces, some or all of which correspond to the first interface in the first aspect of the present disclosure. For example, the interface on the handheld body 2100 for connecting the handheld mode battery and the flight mode battery, and the arm mounting position 2122 correspond to the first interface 101 in the first aspect of the present disclosure. The handheld mode battery 2300, the flight mode battery 2400 and the arm 2500 in the second aspect of the present disclosure correspond to the external devices in the first aspect of the present disclosure. When the handheld mode battery 2300 is connected to the handheld body 2100, the intelligent device operates in the handheld mode; when the flight mode battery 2400 and the arm 2500 are connected to the handheld body 2100, the intelligent device operates in the self-propelled mode (the flight device mode). The handheld body and the flight driving device of the present disclosure can be connected or separated, the handheld body can be used alone in the handheld mode, and can be connected with the flight driving device to be used in the flight device mode, thus solving the problem in the art that the existing intelligent device only has a single usage mode.

Furthermore, the handheld mode battery 2300 and the flight mode battery 2400 in the second aspect of the present disclosure correspond to the second power source in the first aspect of the present disclosure, for supplying power to the external devices and/or the intelligent device.

The features in the first and second aspects of the present disclosure can be combined in any manner, which falls into the protection of the present disclosure, unless there is an obvious conflict which makes such combination impossible.

The handheld body and the flight driving device of the intelligent device provided by the present disclosure can be connected or detached. The handheld body can be used alone in the handheld mode, and can be connected with the flight driving device to be used in the flight device mode, thereby solving the problem in the art that the existing intelligent device only has a single usage mode.

In some embodiments, the gimbal mechanism is provided on the handheld body. The gimbal mechanism serves to adjust the shooting angle and balance and stabilize the shooting module during the movement of the intelligent device, thereby improving the shooting effect.

In some embodiments of the present disclosure, optionally, the intelligent device further comprises a handheld mode battery and a flight mode battery. The handheld mode battery is installed on the handheld body and is used to supply power to the handheld body so that the handheld body can be used in a handheld manner. The flight mode battery is installed on the handheld body to supply power to the handheld body and the flight driving device at the same time in order to have a longer duration of flight.

In some embodiments, compared to the capability of the handheld mode battery, the flight mode battery has a greater capacity, so as to have a longer duration of flight in the flight device mode. Or the handheld mode battery may be configured to have a smaller volume so that it may be grasped easily.

In some embodiments, the flight mode battery may be integrated with the handheld body as the UAV fuselage, which may have the UAV arms installed thereon to carry the UAV fuselage to fly. When the UAV arms are detached, this does not affect the handheld body connected with the handheld mode battery for the handheld use. The overall structure is simple and compact and does not have redundant component and is convenient for use.

In some embodiments of the present disclosure, when the flight mode battery is installed on the handheld body, it may make way for the arm mounting position, so that the UAV arms may be installed on the arm mounting position, and the flight mode battery makes the UAV arm close to the handheld body to avoid the separation of the UAV arms. So the handheld body, the UAV arms and the flight mode battery may form a flyable device, without the need to have an additional device to anchor or fix the UAV arms. The overall structure is simple and compact. After the detachment of the flight mode battery, the three parts separate and can be used and stored easily and separately.

In some embodiments, the handheld mode battery simultaneously occupies the arm mounting position, enhancing the capability of the handheld mode battery and improving the duration of use in the handheld state. And the handheld body and the handheld mode battery together form a continuous surface without a gap, so it is more comfortable for the handheld use and may shield the arm mounting position and serve the function of protection.

In some embodiments of the present disclosure, in the handheld mode, the screen module may be in direct electrical connection with the handheld body so that it may be powered by the handheld mode battery and the volume of the single screen module may be reduced.

In some embodiments of the present disclosure, the intelligent device further comprises a sensor module. For example, when the intelligent device is in the flight device mode, the sensor module is installed on the handheld body to detect obstacles during flight. Optionally, the sensor module comprises a first binocular vision sensor. The first binocular vision sensor may be provided in front of the handheld body to facilitate the detection of obstacles in the front along the flying direction and to avoid the obstacles. Optionally, the handheld body is further provided with a second binocular vision sensor. The second binocular vision sensor may be provided on a position on the handheld body in other directions to detect obstacles or targets.

In some embodiments, the UAV fuselage has a handheld body mounting position formed thereon. The flight driving device may fly alone, and the handheld body may be used alone. And the flight driving device may carry the handheld body and fly together and use the handheld body. So multiple functions may be obtained.

In some embodiments, the flight driving device comprises a flight mode battery, and the handheld body comprises a handheld mode battery. Optionally, the flight mode battery operates to supply power to the flight driving device and the handheld mode battery operates to supply power to the handheld body. They supply power separately and have their respective duration of use.

In some embodiments, the intelligent device further comprises a support frame, and the device modes of the intelligent device further include an erected device mode, so as to further solve the problem in the art that only a single mode is provided.

The aforesaid examples are only those specific modes of implementation of the present disclosure to illustrate the technical solutions of the present disclosure, instead of imposing limitations on the same, and the protection scope of the present disclosure is not limited to this. Notwithstanding the detailed description of the present disclosure made referring to the foregoing examples, a person skilled in the art should understand that within the technical scope disclosed by the present disclosure, any technician familiar with the technical field may still make modification or change as is easily envisaged to the technical solutions recited in the foregoing examples, or perform equivalent replacement for some of the technical features therein. These modifications, changes or replacements do not separate the essence of the corresponding technical solutions from the spirit and scope of the technical solutions of the examples of the present disclosure, and should be covered within the protection scope of the present disclosure. Hence, the protection scope of the present disclosure shall be subject to the protection scope of the claims.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An intelligent device, the intelligent device comprises:
a body and a plurality of removable external devices, the body comprising:
a first interface configured to be connected with the external devices; and
a controller connected with the first interface;
wherein the intelligent device is configured to operate in a handheld mode or a self-propelled mode, depending on the external devices connected with the first interface;
wherein, when the intelligent device operates in the self-propelled mode, the controller is configured to control the external devices.

2. The intelligent device according to claim 1, wherein the self-propelled mode includes at least one of an unmanned ground vehicle (UGV) mode, an unmanned aerial vehicle (UAV) mode, an unmanned ship mode and an unmanned submarine mode; and, the body further comprises a first motor driving circuit, the external devices comprise a device equipped with a power system, and when the device equipped with the power system is connected to the first interface, the first motor driving circuit is configured to drive the device equipped with the power system, so as to set the intelligent device to operate in the self-propelled mode.

3. The intelligent device according to claim 1, wherein the body further comprises an image module configured to acquire images and/or videos, the handheld mode includes at least one of a handheld camera mode and a handheld digital video camera mode, the body further comprises a gimbal, via which the image module is arranged in the body, and which is configured to rotate the image module.

4. The intelligent device according to claim 1, wherein the first interface includes at least one of a wired interface, a wireless interface, a structural connection port, a communication interface, and a power supply interface; wherein the structural connection port is configured to allow a connection and/or quick-release between the body and the external devices; wherein the power supply interface is configured to supply power to the external devices.

5. The intelligent device according to claim 4, wherein the body further establishes connection with the external devices via the wired interface and/or the wireless interface when a distance value between the body and the external devices is less than a predefined threshold.

6. The intelligent device according to claim 1, wherein the external devices comprises a human-computer interaction device establishing connection with the body manually and/or automatically.

7. The intelligent device according to claim 1, wherein the external devices includes at least one of a structural connection component, an electronic connection component and a device equipped with a power system; the external devices further comprises a second interface, via which the external devices further establishes connection with the first interface; the external devices further comprises a second power source for supplying power to the external devices and/or the intelligent device.

8. The intelligent device according to claim 1, wherein the external devices includes at least one of a bracket, a wristband, a UAV arm, an external communication device, a mobile phone, a vehicle driving device, and an underwater driving device; wherein the UAV arm comprises a motor and a propeller; when the bracket or the wristband is connected to the first interface, the intelligent device operates in the handheld mode; when at least one of the UAV arm, the underwater driving device and the vehicle driving device is connected to the first interface, the intelligent device operates in the self-propelled mode.

9. The intelligent device according to claim 8, wherein the UAV arm comprises:
a first arm connected with the first interface;
a second arm hinged with the first arm via a damping component, so as to enable the second arm to rotate towards the first arm by overcoming a damping force of the damping component when the second arm is in an unfolded state relative to the first arm;
wherein the damping component comprises a damping shaft, on which the second arm is sleeved;
wherein a foldable UAV unipod is provided on the first arm and the second arm.

10. The intelligent device according to claim 7, wherein the second power source comprises a handheld mode battery and a self-propelled mode battery, when the handheld mode battery is connected to the first interface, the intelligent device operates in the handheld mode; when the self-propelled mode battery is connected to the first interface, the intelligent device operates in the self-propelled mode.

11. An intelligent device, comprising:
a body comprising a first structural connection port and a master connection contact, the first master connection contact being arranged on the first structural connection port;
a plurality of removable external devices, at least some of which comprises a slave connection contact;
wherein the body may be connected with and/or quickly released from the external devices via the first structural connection port;
wherein the master connection contact is electrically connected with the slave connection contact when the body is in connection with the external devices;
wherein the intelligent device is configured to operate in a handheld mode or a self-propelled mode, depending on the external devices connected with the first structural connection port.

12. The intelligent device according to claim 11, wherein the body further comprises a controller electrically connected with the master connection contact and configured to control the external devices;
wherein the master connection contact is embedded in the first structural connection port;
wherein the first structural connection port is a swallowtail slot.

13. The intelligent device according to claim 12, wherein the external devices further comprise a power system receiving, via the slave connection contact, a control instruction sent by the controller.

14. The intelligent device according to claim 12, wherein the external devices include at least one of a structural connection component, an electronic connection component and a device equipped with a power system; the device equipped with the power system includes at least one of a UAV arm, an underwater driving device and a vehicle driving device; the external devices further comprise a second structural connection port corresponding to the first structural connection port, the slave connection contact being embedded in the second structural connection port.

15. The intelligent device according to claim 11, wherein the external devices comprise a handheld mode battery and a self-propelled mode battery, wherein when the handheld mode battery is connected to the master connection contact, the intelligent device operates in the handheld mode; when the self-propelled mode battery is connected to the master connection contact, the intelligent device operates in the self-propelled mode.

16. A switching method applicable to an intelligent device, comprising:
determining whether the intelligent device satisfies a state switching condition; and
switching the intelligent device from a first state to a second state when the state switching condition is satisfied; wherein the first state corresponding to the intelligent device operated in a handheld mode, and the second state corresponding to the intelligent device operated in a self-propelled mode.

17. The switching method according to claim 16, wherein the state switching condition comprises a shooting state switching condition, the step of switching the intelligent device from the first state to the second state when the state switching condition is satisfied comprises:
switching the intelligent device from a first shooting state to a second shooting state when the shooting state switching condition is satisfied; wherein one shooting state of the first shooting state and the second shooting state is a self-propelled shooting state, and the other is a handheld shooting state.

18. The switching method according to claim 16, wherein the intelligent device comprises a body, and external devices equipped with a power system, the step of determining whether the intelligent device satisfies the state switching condition comprises:
determining that the intelligent device satisfies the shooting state switching condition if change takes place in the connection state between the external devices and the body.

19. The switching method according to claim 16, wherein the step of switching the intelligent device from the first state to the second state comprises:
switching from a first state parameter of the intelligent device in the first state to a second state parameter of the intelligent device in the second state;
wherein the step of switching from the first state parameter of the intelligent device in the first state to the second state parameter of the intelligent device in the second state comprises any one of the following:
switching from a first bandwidth of an image transmission module of the intelligent device in the first state to a second bandwidth in the second state;
switching from a first transmit power of an image transmission module of the intelligent device in the first state to a second transmit power in the second state;
switching from a first brightness of an indicator lamp of the intelligent device in the first state to a second brightness in the second state.

20. The switching method according to claim 16, wherein the step of switching the intelligent device from the first state to the second state comprises:
switching from a first antenna of the intelligent device for receiving and transmitting signals in the first state to a second antenna for receiving and transmitting signals in the second state.
